(19) United States
(12) Patent Application Publication
(10) Pub. No.: US 2024/0349277 A1
(43) Pub. Date: Oct. 17, 2024

(54) On Multiple Grants using Single Downlink Control Information

(71) Applicant: Telefonaktiebolaget LM Ericsson (publ), Stockholm (SE)

(72) Inventors: Bikramjit Singh, Raasepori (FI); Alexey Shapin, Linköping (SE); Kittipong Kittichokechai, Järfälla (SE)

(21) Appl. No.: 18/699,095

(22) PCT Filed: Oct. 8, 2021
(86) PCT No.: PCT/EP2021/077811

§ 371 Date: Apr. 5, 2024

(51) Int. Cl. H04W 72/1268; H04B 7/06; H04L 1/1812; H04W 72/231

(52) U.S. Cl. CPC H04W 72/1268; H04B 7/0626; H04L 1/1812; H04W 72/231

(57) ABSTRACT

A method performed in a radio access node of a wireless network is provided that includes determining (1901) for a single downlink control information, DCI, to schedule one or more downlink, DL, and/or uplink, UL, control channel allocations, and/or one or more of dynamic DL shared channel allocations and/or one or more DL semi-persistent scheduling, SPS, allocations and/or one or more dynamic UL shared channel allocations, and/or one or more UL configured grant, CG, allocations, and/or one or more DL and/or UL shared channel allocations comprising or multiplexed with control information. The method further includes transmitting (1903) the single DCI to a user equipment, UE, to schedule the one or more UL and/or DL control channel allocations and the one or more of DL dynamic shared channel allocations and/or DL SPS and/or UL dynamic shared channel allocations and/or UL CG allocations and/or DL and/or UL shared channel allocations.

### TECHNICAL FIELD

The present disclosure relates generally to communications, and more particularly to communication methods and related devices and nodes supporting wireless communications.

### BACKGROUND

Physical Downlink Shared Channel (PDSCH) scheduling or allocation, respectively

Third Generation Partnership Project (3GPP) Technical Specification (TS) 38.214 V16.4.0 section 5.1 describes dynamic and SPS (semi-persistent scheduling) PDSCH scheduling in detail. FIG. 1 illustrates dynamic DL (downlink) scheduling and FIG. 2 illustrates DL SPS.

In FIG. 1, a downlink control information (DCI) (transmitted in PDCCH (Physical Downlink Control Channel) schedules a PDSCH at K0 slots with respect to the DCI. The DCI contains the parameters to enable a user equipment (UE) to decode the PDSCH. After K1 slots with respect to the end of the PDSCH, the UE must send HARQ-ACK (hybrid automatic repeat request-acknowledgement) feedback for the received PDSCH.

In FIG. 2, an SPS activation DCI allocated SPS PDSCH occasions. The activation DCI may indicate timing for HARQ-ACK PUCCH (Physical Uplink Control Channel) occasions where PDSCH is Acked or Nacked in a respective PUCCH.

### Physical Uplink Shared Channel (PUSCH) Scheduling or Allocation, Respectively

3GPP TS 38.214 Section 6.1 describes dynamic and CG (configured grant) PUSCH scheduling in detail. FIG. 3 illustrates dynamic uplink (UL) scheduling and FIG. 4 illustrates UL CG.

In FIG. 3, a DCI (transmitted in PDCCH) schedules a PUSCH at K2 slots with respect to the DCI. The DCI contains the parameters to enable UE to transmit PUSCH. In FIG. 4, a CG activation DCI allocates periodic PUSCH occasions.

In NR (Next Radio), there is no HARQ-ACK feedback in response to the allocated UL transmission. If the gNB cannot receive the UL transmission correctly, the gNB can simply schedule for a retransmission. However, for NR operation in unlicensed band (NR-U), the UE may receive feedback for its UL data transmission. Further in NR-U, a UE can be scheduled dynamically multi-PUSCH (multiple transport blocks (TB)) by a single DCI where the multiple PUSCHs represent multiple HARQ processes. In section 5.4.2.1 of 3GPP TS 38.331 V16.3.1, the following is mentioned:
“When a single DCI is used to schedule multiple PUSCH, the UE is allowed to map generated TB(s) internally to different HARQ processes in case of LBT failure(s), i.e. UE may transmit a new TB on any HARQ process in the grants that have the same transport block size (TBS), the same redundancy version (RV) and the new data indicators (NDIs) indicate new transmission.”

In modern wireless technologies, i.e. 3GPP standards like long term evolution (LTE) and NR, radio resource allocation/and/or radio resource management is done by a base station. In downlink communication link the base station is aware of available data for transmission and can schedule needed amount of resources with very good precision. For uplink communication link the scheduling becomes more challenging, because base station cannot know for sure how much data is available for transmission. There are known techniques to inform base station about buffer status, e.g. scheduling request and buffer status report, however, quite many uncertainties always exist due to delay of buffer status message and limited precision of signaling.

A base station (BS) usually allocates time and/or frequency and/or spatial and/or code and/or other kind of resources either without any information about buffer status in a wireless device (WD) or based on estimation of data in a WD's buffer. The first case usually happens during initial data exchange between the BS and a WD, then the WD can send buffer status report to inform the BS about data available for transmission. The WD can periodically send an update about buffer state.

When the BS allocates uplink resources, the BS sends a scheduling command or a grant. The grant can be dynamic (sent some time before the WD can transmit on granted resources) or static or semi-persistent or configured.

In NR, terminals and network nodes (hereafter UE and gNodeB, respectively) data transmission is controlled by the nodes using grants containing among other things the details in allocated spectrum resource and the modulation and coding to transmit over that resource. The modulation and coding scheme (MCS) is signaled in the downlink control information (DCI). DCI message typically is sent over Physical Downlink Control Channel (PDCCH). An example of this process in DL and UL is illustrated in FIG. 5.

The modulation and coding scheme field is an index pointing to entries to the MCS table in the 3GPP specification, which once combined together with the resource allocation, will result in the transport block size (TBS) that will be transmitted. In the legacy, the reason for a range of value for MCS is that the UE ability to reliably receive or transmit depends on its location in the cell. A UE near the gNodeB has a low path loss and can be scheduled with a high order modulation which a UE in the cell edge faces both high path loss and intercell interference, so that the transmission must be coded with a stronger code rate and transmitted with a lower order modulation.

In Rel-16 3GPP in eURLLC study item and working item there was a discussion around intra-UE multiplexing. In scenarios when one radio link to or from UE carries multiple traffic types, those traffic flows can have different latency and/or reliability requirements. For being spectral efficient, the scheduler should ensure different reliability level through right resource allocation strategy and appropriate MCS. Moreover, collisions may happen between dynamically and semi-persistently scheduled data transmissions. As it was discussed in Rel-16 eURLLC, in case of overlapping in time only prioritization procedure is possible, meaning that low priority transport block should be discarded, and only high priority transport block should be transmitted or received.

Regarding how a UE determines physical downlink control channel assignment, see Section 10.1, 3GPP TS 38.213 where the configuration of search space sets and CORESETs (common resource sets) in which UE monitors PDCCH candidates are described.

### SPS

NR supports Semi-Persistent Scheduling (SPS) in downlink wherein SPS is similar to CG Type 2. For both SPS and CG Type 2 the L1 signaling (DCI message) activate and de-activate respective configurations. The DCI message includes time- and frequency allocation for the transmission opportunities of the SPS or CG but also other transmission parameters such as MCS (Modulation and Coding Scheme), number of layers etc. In NR Rel-16, the activation DCI may also include number of repetitions that can be either slot-based repetition or so-called mini-slot-based. For slot-based transmissions are repeated with same time-domain allocation within each consecutive slot of repeated transmissions while for mini-slot-based transmissions the transmissions may be repeated within a slot. Repetitions can be configured with or without frequency-hopping. If frequency-hopping is enabled the repeated transmissions may have different frequency-domain allocations. For further details, refer to Release 16 specifications 3GPP TS 38.213, v16.4.0, 3GPP TS 38.214 v16.4.0.

HARQ-ACK for SPS or Dynamic PDSCH

### There are 3 Types of HARQ-ACK Code Construction in NR:

Semi-static code construction (Type 1)
Dynamic code construction (Type 2)
One-shot feedback, introduced in Rel-16 for NR-U, in Rel-17 for NR (Type 3)

The procedure for receiving downlink transmission is that the UE first monitors and decodes a PDSCH in slot n which points to a DL data scheduled in slot n+K0 slots (K0 is larger than or equal to 0). The UE then decodes the data in the corresponding PDSCH. Finally based on the outcome of the decoding the UE sends an acknowledgement of the correct decoding (ACK) or a negative acknowledgement (NACK) to the gNB at time slot n+K0+K1 (in case of slot aggregation n+K0 would be replaced by the slot where PDSCH ends). Both of K0 and K1 are indicated in the DCI. The resources for sending the acknowledgement are indicated by PUCCH resource indicator (PRI) field in the DCI which points to one of PUCCH resources that are configured by higher layers.

Depending on DL or UL slot configurations, or whether carrier aggregation, or per code-block group (CBG) transmission used in the DL, the feedback for several PDSCHs may need to be multiplexed in one feedback. This is done by constructing HARQ-ACK codebooks. In NR, the UE can be configured to multiplex the ACK or NACK bits using a semi-static codebook or a dynamic codebook.

Type 1 or semi-static codebook consists of a bit sequence where each element contains the ACK or NACK bit from a possible allocation in a certain slot, carrier, or transport block (TB). When the UE is configured with CBG and/or time-domain resource allocation (TDRA) table with multiple entries, multiple bits are generated per slot and TB (see below). It is important to note that the codebook is derived regardless of the actual PDSCH scheduling. The size and format of the semi-static codebook is preconfigured based on the mentioned parameters. The drawback of semi-static HARQ ACK codebook is that the size is fixed, and regardless of whether there is a transmission or not a bit is reserved in the feedback matrix.

On the case when a UE has a TDRA table with multiple time-domain resource allocation entries configured: The table is pruned (i.e. entries are removed based on a specified algorithm) to derive a TDRA table that only contains non-overlapping time-domain allocations. One bit is then reserved in the HARQ code block (CB) for each non-overlapping entry (assuming a UE is capable of supporting reception of multiple PDSCH in a slot).

To avoid reserving unnecessary bits in a semi-static HARQ codebook, in NR a UE can be configured to use a type 2 or dynamic HARQ codebook, where an ACK or NACK bit is present only if there is a corresponding transmission scheduled. To avoid any confusion between the gNB and the UE, on the number of PDSCHs that the UE has to send a feedback for, a counter downlink assignment indicator (DAI) field exists in DL assignment, which denotes accumulative number of {serving cell, PDCCH occasion} pairs in which a PDSCH is scheduled to a UE up to the current PDCCH. In addition to that, there is another field called total DAI, which when present shows the total number of {serving cell, PDCCH occasion} up to (and including) all PDCCHs of the current PDCCH monitoring occasion. The timing for sending HARQ feedback is determined based on both PDSCH transmission slot with reference to PDCCH slot (K0) and the PUCCH slot that contains HARQ feedback (K1).

FIG. 6 illustrates the timeline in a simple scenario with two PDSCHs and one feedback. In this example there is in total 4 PUCCH resources configured, and the PRI indicates PUCCH 2 to be used for HARQ feedback.

In NR Rel-15, a UE can be configured with maximum of four PUCCH resource sets for transmission of HARQ-ACK information. Each resource set is associated with a range of UCI payload bits including HARQ-ACK bits. The first resource set is always associated to 1 or 2 HARQ-ACK bits and hence includes only PUCCH format 0 or 1 or both. The range of payload values (minimum of maximum values) for other resource sets, if configured, is provided by configuration except the maximum value for the last resource set where a default value is used, and the minimum value of the second resource set being 3. The first resource set can include a maximum of 32 PUCCH resources of PUCCH format 0 or 1. Other resource sets can include a maximum of 8 bits of format 2 or 3 or 4.

As described previously, the UE determines a slot for transmission of HARQ-ACK bits in a PUCCH corresponding to PDSCHs scheduled or activated by DCI via the k1 value provided by configuration or a field in the corresponding DCI. The UE forms a codebook from the HARQ-ACK bits with associated PUCCH in a same slot via corresponding k1 values.

The UE determines a PUCCH resource set that the size of the codebook is within the corresponding range of payload values associated to that resource set.

The UE determines a PUCCH resource in that resource set if the resource set is configured with maximum of eight PUCCH resources, by a field in the last DCI associated to the corresponding PDSCHs. If the resource set is the first resource set and is configured with more than eight resources, a PUCCH resource in that resource set is determined by a field in the last DCI associated to the corresponding PDSCHs and implicit rules based on the control channel element (CCE).

A PUCCH resource for HARQ-ACK transmission can overlap in time with other PUCCH resources for channel status information (CSI) and/or scheduling request (SR) transmissions as well as PUSCH transmissions in a slot. In case of overlapping PUCCH and/or PUSCH resources, first the UE resolves overlapping between PUCCH resources, if any, by determining a PUCCH resource carrying the total UL control information (UCI) (including HARQ-ACK bits) such that the UCI multiplexing timeline requirements are met. There might be partial or completely dropping of CSI bits, if any, to multiplex the UCI in the determined PUCCH resource. Then, the UE resolves overlapping between PUCCH and PUSCH resources, if any, by multiplexing the UCI on the PUSCH resource if the timeline requirements for UCI multiplexing is met.

### Semi-Static (Type-1) HARQ Codebook

Type 1 or semi-static codebook consists of a bit sequence where each element contains the A (acknowledgement) bit or N\negative acknowledgment) bit from a possible allocation in a certain slot, carrier, or transport block (TB). When the UE is configured with CBG and/or time-domain resource allocation (TDRA) table with multiple entries, multiple bits are generated per slot and TB (see below). It is important to note that the codebook is derived regardless of the actual PDSCH scheduling. The size and format of the semi-static codebook is preconfigured based on the mentioned parameters. The drawback of semi-static HARQ ACK codebook is that the size is fixed, and regardless of whether there is a transmission or not a bit is reserved in the feedback matrix.

On the case when a UE has a TDRA table with multiple time-domain resource allocation entries configured: The table is pruned (i.e. entries are removed based on a specified algorithm) to derive a TDRA table that only contains non-overlapping time-domain allocations. One bit is then reserved in the HARQ CB for each non-overlapping entry (assuming a UE is capable of supporting reception of multiple PDSCH in a slot).

### Dynamic (Type-2) HARQ Codebook

In type 2 or dynamic HARQ codebook, an A bit or N bit is present in a codebook only if there is a corresponding transmission scheduled. To avoid any confusion between the gNB and the UE, on the number of PDSCHs that the UE has to send a feedback for, a counter downlink assignment indicator (DAI) field exists in DL assignment, which denotes accumulative number of (serving cell, PDCCH occasion) pairs in which a PDSCH is scheduled to a UE up to the current PDCCH. In addition to that, there is another field called total DAI, which when present shows the total number of (serving cell, PDCCH occasion) up to (and including) all PDCCHs of the current PDCCH monitoring occasion. The timing for sending HARQ feedback is determined based on both PDSCH transmission slot with reference to PDCCH slot (K0) and the PUCCH slot that contains HARQ feedback (K1).

A dynamic codebook would be straightforward if there were no errors in the downlink control signaling. However, in the presence of an error in the downlink control signaling, the device and gNB may have different understanding on the number of scheduled carriers, which would lead to an incorrect codebook size and possibly corrupt the feedback report for all carriers, and not only for the ones for which the downlink controls signaling was missed. Assume, as an example, that the device was scheduled for downlink transmission in two subsequent slots but missed the PDCCH and hence scheduling assignment for the first slot. In response the device will transmit an acknowledgment for the second slot only, while the gNB tries to receive acknowledgments for two slots, leading to a mismatch. To handle these error cases, NR uses the downlink assignment index (DAI) included in the DCI containing the downlink assignment. The DAI field is further split into two parts, a counter DAI (cDAI) and, in the case of carrier aggregation, a total DAI (tDAI). The counter DAI (cDAI) included in the DCI indicates the number of scheduled downlink transmissions up to the point the DCI was received in a carrier first, time second manner. The total DAI included in the DCI indicates the total number of downlink transmissions across all carriers up to this point in time, that is, the highest cDAI at the current point in time.

### Enhanced Dynamic (Type-2) HARQ Codebook

In Rel-16, enhanced dynamic codebook or enhanced Type-2 codebook based on Type 2 codebook is introduced to enable retransmission of the HARQ feedback corresponding to the used HARQ processes. If, for any reason, the scheduled codebook was not received, the retransmission of the feedback can be requested by the gNB. A toggle bit, new feedback indicator (NFI), is added in the DCI to indicate whether the HARQ-ACK feedback from the UE was received by the gNB or not. If toggled, the UE assumes that the reported feedback was correctly received. Otherwise, if the gNB fails to receive the scheduled PUCCH the UE is expected to retransmit the feedback. In the latter case, the DAI (cDAI or tDAI) is not reset, instead the DAI are accumulated within a PDSCH group until NFI for the PDSCH group is toggled.

As the triggering of additional HARQ feedback reporting occurs with ambiguous timing relation to the associated PDSCHs, PDSCH grouping is introduced. PDSCH group is defined as the PDSCH(s) for which the HARQ-ACK information is originally indicated to be carried in a same PUCCH. PDSCH grouping allows the gNB to explicitly indicate which codebook is missing. The group index is explicitly signalled in the scheduling DCI. If enhanced dynamic codebook is configured, two PDSCH groups are supported. Together with the group identification (ID), the gNB signals a request group ID which is a 1-bit field. By referring to the group Id (ID), request ID (RI), and the value of the NFI field in the DCI, the UE can figure out if the next feedback occasion should include only initial transmission or also retransmission of feedback corresponding to PDSCH(s) associated with the indicated group.

Similar to NR, the DAI value is also included in the UL grant scheduling PUSCH. As an additional functionality, the gNB can indicate the DAI value for each group separately in the UL grant to resolve any possible ambiguity at the UE side.

### One-Shot (Type-3) HARQ Codebook

The UE can be configured to monitor feedback request of a HARQ-ACK codebook containing all DL HARQ processes. The feedback can be requested in DL DCI format 1_1. In response to the trigger, the UE reports the HARQ-ACK feedback for all DL HARQ processes. The format of the feedback, either CBG-based HARQ-ACK or TB-based HARQ-ACK, can be configured to be part of the one-shot HARQ feedback for the component carriers.

Additionally, to resolve any possible ambiguity between the gNB and the UE that might be caused by possible mis-detection of PDCCH(s), the UE can be configured to report the corresponding latest NDI value for a latest received PDSCH for that HARQ process along with the corresponding HARQ-ACK for the received PDSCH. From gNB perspective, if the NDI value matches the last transmitted value, it indicates that the reported HARQ-ACK feedback correctly corresponds to the HARQ process with pending feedback. Otherwise, the mismatch suggests that the UE is reporting an outdated feedback.

### Priority Indication of HARQ-ACK

In Rel-16, two-level PHY priority can be indicated in the DCI for HARQ-ACK corresponding to a dynamically scheduled PDSCH, or radio resource control (RRC)-configured for HARQ-ACK corresponding to each DL SPS configuration. This priority indication can be used to determine the priority of the HARQ-ACK codebook for uplink collision handling. NR Rel-16 supports up to two HARQ-ACK codebooks with different priorities to be simultaneously constructed. This includes one being slot-based and one being sub-slot-based, both being slot-based, or both being sub-slot-based.

### Dynamic PUSCH

The basic procedure for transmitting UL data in 4G and 5G systems is dynamic scheduling as illustrated in FIG. 7. In this case, the UE will send a SR (scheduling request) and/or a BSR (buffer status report) to the gNB to indicate that it has data (SR) and the amount of data (BSR). The gNB will then send grant(s) to the UE tailored to the amount and priority of the data.

The hybrid automatic repeat request (HARQ) protocol is widely used in 4G and 5G systems and will undoubtedly be used in future systems to provide fast re-transmissions on the medium access control (MAC) layer. It is used both in UL and DL and can be configured in different ways, e.g. the maximum number of re-transmissions, operating block error rate (BLER), possible repetitions, etc. One way to implement the HARQ protocol is to use autonomous re-transmissions, i.e. the transmitter always performs a given number of HARQ retransmission attempts. Autonomous retransmissions are especially suitable in one-to-many or many-to-one communication scenarios since using HARQ feedback from many recipients or reliably transmitting HARQ feedback to many recipients is complicated. With a suitable setting for the number of HARQ transmission attempts using autonomous re-transmissions, most transmission errors can be recovered. Dynamic scheduling is resource efficient since the grants are tailored for the amount of data the UE has reported.

### CG (Configured Grant)

### Configured Scheduling in NR Rel-15

In NR, configured scheduling is used to allocate semi-static periodic assignments or grants for a UE. For uplink, there are two types of configured scheduling schemes: Type 1 and Type 2. For Type 1, configured grants are configured via RRC signaling only. For Type 2, similar configuration procedure as SPS UL in LTE was defined, i.e. some parameters are preconfigured via RRC signaling and some physical layer parameters are configured via MAC scheduling procedure. The detail procedures can be found in 3GPP TS 38.321 clause 5.8.2.

Like for SPS in LTE, the CG periodicity is RRC configured, and this is specified in the ConfiguredGrantConfig information element (IE). Different periodicity values are supported in NR depending on the subcarrier spacing. For example, for 15 and 30 kHz subcarrier spacing (SCS), the following periodicities are supported, expressed in a number of OFDM symbols:
15 kHz SCS
   2, 7, and n*14 orthogonal frequency division multiplex (OFDM) symbols
   where n ∈{1, 2, 4, 5, 8, 10, 16, 20, 32, 40, 64, 80, 128, 160, 320, 640}
30 kHz SCS
   2, 7, and n*14 OFDM symbols
   where n ∈{1, 2, 4, 5, 8, 10, 16, 20, 32, 40, 64, 80, 128, 160, 256, 320, 640, 1280}

For Type1 configured grants, in addition to the periodicity, the time domain allocation of PUSCH is configured purely via RRC signalling:
timeDomainOffset: Provides a slot offset with respect to SFN 0
timeDomainAllocation: Provides an index into a table of 16 possible combinations of PUSCH mapping type (TypeA or TypeB), start symbol S for the mapping (S=OFDM symbol 0, 2, 4, or 8 within a slot), and length L of the mapping (L=4, 6, 8, 10, 12, or 14 OFDM symbols).

For the case of Type2 configured grants, the periodicity is configured by RRC in the same way as for Type1, but the slot offset is dynamically indicated and is given by the slot in which the UE receives the DCI that activates the Type2 configured grant. In contrast to Type1, the time domain allocation of PUSCH is indicated dynamically by DCI via the time domain resource assignment field in the same way as for scheduled (non-CG) PUSCH. This DCI field indexes a table of start symbol and length (SLIV) values.

A configuredGrantTimer (CGT) is introduced to prevent both of the following cases to occur:
1. a configured grant to override a transport block (TB) scheduled with a dynamic grant (i.e., new transmission or retransmission)
2. a configured grant to override an initial TB with another configured grant (i.e., new transmission)

Meanwhile, there is no explicit HARQ ACK or NACK in Rel-15. The gNB signals a grant indicating a new transmission to the UE which can inexplicitly indicate “ACK”.

The CGT is started or restarted for a HARQ process which is configured for a configured grant, upon transmission on PUSCH with a dynamic grant (i.e., new transmission or retransmission) or a configured grant (i.e., new transmission). It is stopped when either of below cases occur:
1. the UE has received a PDCCH indicating configured grant Type 2 activation.
2. the corresponding HARQ process has been ACKed (i.e., a grant indicating a new transmission for the associated HARQ process)

### Expiration of the CGT Means ACK for the Associated HARQ Process.

### Configured Scheduling in NR Rel-16

The CG is similar to NR rel-15 with updates in parameters. For example, multiple CGs are supported per bandwidth part (BWP) for UE. For details, refer to 3GPP Release 16 specifications TS 38.213, v16.4.0, TS 38.214 v16.4.0

Compared to the configured grant in NR Rel-15 specifications, in addition, a UE can trigger a retransmission autonomously using a configured grant for a HARQ process configured with autonomous uplink (AUL) when the CG retransmission timer is expired while the UE has not received HARQ feedback for the HARQ process in NR-U spectrum. A timer “CG retransmission timer (CGRT)” is defined accordingly. This timer is configured by the RRC parameter cg-RetransmissionTimer in the ConfiguredGrantConfig. The CGRT is started for a HARQ process configured with AUL upon the data transmission using a configured grant, and a retransmission using another configured grant is triggered when the CGRT expires.

With this added functionality, it is beneficial for the UE as the UE can avoid the HARQ process to be stalled in case the gNB has missed the HARQ transmission initiated by the UE. However, an issue is observed that a UE may just continuously initiate autonomous HARQ retransmissions for a HARQ process for a very long time. However, the gNB may not successfully receive the TB either due to bad radio channel quality or the channel is seldom obtained due to LBT failures. This is certainly not desirable because the packet may become too old and any retransmission attempt would just further congest the channel and further affect the latency of other packets in the UL buffer. The RLC (Radio Link Control) layer at the UE may sooner or later trigger RLC retransmissions for a RLC PDU (protocol data unit) which is still under retransmissions in the HARQ. The retransmitted RLC PDU would occupy a different HARQ process. In this case, the UE would then maintain two HARQ processes in transmission for the same RLC PDU. The RLC receiver at the gNB may receive two RLC PDU duplicates. This may create a trouble in case a wraparound of the RLC sequence number occurs. The second received RLC PDU may be treated as a new data and forwarded upward instead the PDU should be dropped.

Therefore, it is necessary to introduce a maximum limit on AUL retransmissions of a HARQ process triggered by a UE. To address this issue, a timer is configured to indicate the maximum amount of time for the UE to complete transmission of an HARQ process, i.e. when the timer expires the UE should flush the HARQ buffer for this HARQ process and transmit new data associated to it. It has been agreed to use an existing timer configuredGrantTimer (CGT) for this purpose. If both CGT and CG retransmission timer (CGRT) are configured for a HARQ process, both timers can be operated in parallel. In this way, the UE can perform HARQ retransmission using CG resources for a HARQ process while CGT is running for the process. The value of CGT should be longer than that of CG retransmission timer. The HARQ buffer is flushed at expiry of CGT. An example of the procedure is illustrated in FIG. 8.

A UE can be provided with multiple active configured grants for a given bandwidth part (BWP) in a serving cell. The introduction of multiple configured grants would serve at least for enhancing reliability and reducing latency of critical services. In addition, it is also being discussed to apply multiple configured grants for allowing the UE to switch to slot-based transmissions after initiating the COT (channel occupancy time) to minimize DMRS (demodulation reference signal) and UCI overhead in the unlicensed spectrum.

For each CG configuration, there are a number of HARQ processes in the HARQ process pool assigned. There is also a separate CGT timer and CGRT setting associated with each CG configuration. It is allowed to share HARQ processes between CG configurations, which can give better configuration flexibility. In addition, if each CG configuration has separate associated HARQ processes, the HARQ process space may become limited for the UE.

Since a logical channel (LCH) can be mapped to multiple CG configurations, meaning the UE can transmit the data of the LCH using multiple active CG resources at the same time. For a TB which was transmitted using a CG resource, it is allowed to use any CG resource among the set of CG resources mapped to the LCH which comes earliest in the time to perform retransmission, this can reduce the latency. In addition, the selected resource shall provide same size as the same initial TB to avoid rate-matching on the TB. In addition, the UE shall stick to the same HARQ process for transmission or retransmission of a TB.

The CGT timer for a HARQ process shall be only started when the TB using this HARQ process is initially transmitted. The value of the CGT timer is set according to the CG configuration or resource which is used for the initial transmission. In parallel, the CGRT shall be started or restarted and set to the timer value which is used for every transmission or retransmission attempt. If the initial transmission of a TB uses the resource in CG configuration 1, the CGRT is started using the timer value configured in CG configuration 1. The next retransmission of the TB is performed with the resource in CG configuration 2. The CGRT need to be restarted and set to the timer value configured in CG configuration 2.

The HARQ process number field in the UL DCI (e.g., format 0-0 or format 0-1) scrambled by CS-RNTI (channel state-radio network temporary identifier) is used to indicate which configuration is to be activated and which configuration(s) is (are) to be released. In the DCI, NDI in the received HARQ information is 0.

Upon reception of an activation or reactivation or deactivation command, the UE provides a confirmation medium access control control element (MAC CE) to the gNB. The MAC CE contains a bitmap of CG configurations. In the bitmap field, each bit corresponds to a specific CG configuration (i.e., the bit position corresponds to the CG index).

Configured Grant with Repetition

Repetition of a TB is also supported in NR, and the same resource configuration is used for K repetitions for a TB including the initial transmission. The higher layer configured parameters repK and repK-RV define the K repetitions to be applied to the transmitted transport block, and the redundancy version pattern to be applied to the repetitions. For the nth transmission occasion among K repetitions, n=1, 2, . . . , K, it is associated with (mod(n−1,4)+1)th value in the configured RV (redundant value) sequence. The initial transmission of a transport block may start at
the first transmission occasion of the K repetitions if the configured RV sequence is {0,2,3,1},
any of the transmission occasions of the K repetitions that are associated with RV=0 if the configured RV sequence is {0,3,0,3},
any of the transmission occasions of the K repetitions if the configured RV sequence is {0,0,0,0}, except the last transmission occasion when K=8.

For any RV sequence, the repetitions shall be terminated after transmitting K repetitions, or at the last transmission occasion among the K repetitions within the period P, or when a UL grant for scheduling the same TB is received within the period P, whichever is reached first. The UE is not expected to be configured with the time duration for the transmission of K repetitions larger than the time duration derived by the periodicity P.

For both Type 1 and Type 2 PUSCH transmissions with a configured grant, when the UE is configured with repK>1, the UE shall repeat the TB across the repK consecutive slots applying the same symbol allocation in each slot. If the UE procedure for determining slot configuration, as defined in subclause 11.1 of 3GPP TS 38.213, determines symbols of a slot allocated for PUSCH as downlink symbols, the transmission on that slot is omitted for multi-slot PUSCH transmission.

### NR-U CG

### A Brief Description of Configured Grant in NR-U

Same as in NR, a UE in NR-Unlicensed (NR-U) can be semi-statically scheduled for uplink transmission based on Type 1 or Type 2 configured grant. There have been specific enhancements in configured grant related to time-domain resource allocation, configured grant UCI (CG-UCI), and autonomous uplink (AUL) transmission.

### CG Re-Transmission Timer

In NR-U a new timer is introduced named as CG re-transmission timer (CGRT). This timer can be used for autonomous uplink transmission (AUL). There is also another timer configuredGrantTimer (CGT). CGT limits maximum AUL retransmission attempts for a HARQ process. When the CGT expires the UE should flush the HARQ buffer for this HARQ process and transmit new data associated to it.

As stated in Section 5.4.2.2 of 3GPP TS 38.321 V16.2.1, cg-RetransmissionTimer enables retransmission without dynamic grant:
“Retransmissions are performed on the resource and, if provided, with the MCS indicated on PDCCH, or on the same resource and with the same MCS as was used for last made transmission attempt within a bundle, or on stored configured uplink grant resources and stored MCS when cg-RetransmissionTimer is configured.”

Section 5.8.2 of the 3GPP TS 38.321 V16.2.1states:
“RRC configures the following parameters when retransmissions on configured uplink grant is configured:
   cg-RetransmissionTimer: the duration after a configured grant (re)transmission of a HARQ process when the UE shall not autonomously retransmit that HARQ process.”

This means that during that duration, the UE shall not retransmit (even if there is opportunity) and after that period, the UE can transmit on the next available CG occasion. In other words, UE does not retransmit between t=0 and t=cg-RetransmissionTimer but can transmit after t=cg-RetransmissionTimer. The UE cannot transmit exactly at the t=cg-RetransmissionTimer, as it has to transmit on the configured CG resource which may be some time after like t=cg-RetransmissionTimer+t_1

Section 5.4.1 of TS 38.321 V16.2.1 states:
“For configured uplink grants neither configured with harq-ProcID-Offset2 nor with cg-RetransmissionTimer, the HARQ Process ID associated with the first symbol of a UL transmission is derived from the following equation:

HARQ Process ID=[floor(CURRENT_symbol/periodicity)] modulo nrofHARQ-Processes

For configured uplink grants with harq-ProcID-Offset2, the HARQ Process ID associated with the first symbol of a UL transmission is derived from the following equation:

HARQ Process ID=[floor(CURRENT_symbol/periodicity)] modulo nrofHARQ-Processes+harq-ProcID-Offset2
where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in 3GPP TS 38.211.

For configured uplink grants configured with cg-RetransmissionTimer, the UE implementation select an HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.”

“NOTE 5: If cg-RetransmissionTimer is not configured, a HARQ process is not shared between different configured grant configurations in the same BWP.”

Section 6.1.2.3.1 of TS 38.214 V16.3.0 states:
“The higher layer parameter repK-RV defines the redundancy version pattern to be applied to the repetitions. If cg-RetransmissionTimer is provided, the redundancy version for uplink transmission with a configured grant is determined by the UE.”

### CG-UCI

CG-UCI is included in every CG-PUSCH transmission and includes the information listed in Table 1. CG-UCI is mapped as per Rel-15 rules with CG-UCI having the highest priority. It is mapped on the symbols starting after first DMRS symbol. To determine the number of REs used for CG-UCI, the mechanism of beta-offset in Rel-15 NR for HARQ-ACK on CG-PUSCH is reused. Nonetheless, a new RRC configured beta-offset for CG-UCI is defined.

TABLE 1
CG-UCI content
UCI content

HARQ
RV
NDI
COT sharing information
CRC

If CG-PUSCH resources overlap with PUCCH carrying CSI-part1 and/or CSI-part 2, the latter can be sent on CG-PUSCH on CG-PUSCH. RRC configuration can be provided to the UE indicating whether to multiplex CG-UCI and HARQ-ACK. If configured, in the case of PUCCH overlapping with CG-PUSCH(s) within a PUCCH group, the CG-UCI and HARQ-ACK are jointly encoded as one UCI type. Otherwise, configured grant PUSCH is skipped if CG-PUSCH overlaps with PUCCH that carries HARQ ACK feedback.

### Downlink Feedback Information (DFI)

To reduce the signaling overhead corresponding to explicit feedback transmission, NR-U supports a new DCI format, downlink feedback information (“CG-DFI”), that carry HARQ-ACK bitmap for all UL HARQ processes from the same UE. Additionally, the gNB may trigger an adaptive retransmission using a dynamic grant.

Section 6.1 of 3GPP TS 38.214 V 16.3.0 states:
If a UE receives an ACK for a given HARQ process in CG-DFI in a PDCCH ending in symbol i to terminate a transport block repetition in a PUSCH transmission with a configured grant on a given serving cell with the same HARQ process after symbol i, the UE is expected to terminate the repetition of the transport block in a PUSCH transmission starting from a symbol j if the gap between the end of PDCCH of symbol i and the start of the PUSCH transmission in symbol j is equal to or more than N2 symbols. The value N2 in symbols is determined according to the UE processing capability defined in Clause 6.4, and N2 and the symbol duration are based on the minimum of the subcarrier spacing corresponding to the PUSCH and the subcarrier spacing of the PDCCH indicating CG-DFI.

### SUMMARY

In recent 3GPP contribution R1-2007558 (FIG. 10), the use of single DCI to schedule multiple mix of DL and UL shared channel allocations is mentioned for NR operation above 52.6 GHz, but the details are simply missing. It should be noted that the mentioned multiple scheduled transmission are restricted to transmission of the shared channels.

There currently exist certain challenge(s). Legacy scheduling methods based on using a single DCI equip us to schedule/activate one of the following:
Dynamic DL transmission
DL SPS
Dynamic UL transmission
UL CG
Multiple-PUSCH dynamic UL transmission (e.g., in NR-U)

Therefore, it can be an object of the inventive concepts to provide measures with which the flexibility in scheduling, e.g., various combinations of above mentioned type of transmissions, is enabled in an efficient and easy way.

In 5G, use cases apart from traditional eMBB scenario have emerged, e.g., MTC and industrial IoT. In the next generation of wireless cellular technologies, it is inevitable that more future use cases will emerge. The traffic of these use cases may depict certain patterns and characteristics which are different from the traditional ones. For example, future use cases both in consumer and industrial domains can be expected to be much more dynamic and interactive. Traditional scheduling which requires a separate/individual DCI for each transmission between gNB and UE would not be sufficiently flexible nor resource efficient. In addition, in some specific scenario where an UL-heavy time-division duplexing (TDD) pattern is used, it may be difficult to handle various scheduling using separate DCIs because of limited DL opportunities for DCI transmission.

Various embodiments focus on a type of scheduling design using a single DCI that is not constrained by the legacy scheduling. They include scheduling methods which can e.g. provide plurality of grants, e.g., mix of DL and UL grant.

According to some embodiments of inventive concepts, a method performed in a radio access node of a wireless network includes determining for a single downlink control information, DCI, to schedule:
one or more DL and/or UL control channel allocations, and/or
one or more of dynamic DL shared channel allocations and/or
one or more DL semi-persistent scheduling, SPS, allocations and/or
one or more dynamic UL shared channel allocations, and/or
one or more UL configured grant, CG, allocations, and/or
one or more DL shared channel allocations comprising or multiplexed with control information and/or
one or more UL shared channel allocations comprising or multiplexed with control information.
   The method further includes transmitting the single DCI to a user equipment, UE, to schedule the one or more UL and/or DL control channel allocations and the one or more of DL dynamic shared channel allocations and/or DL SPS and/or UL dynamic shared channel allocations and/or UL CG allocations and/or DL shared channel allocations comprising or multiplexed with control information and/or UL shared channel allocations comprising or multiplexed with control information control information.

Advantages that may be achieved by various embodiments of inventive concepts described herein may enable multiple allocations/transmission granted to a UE by using a single DCI. This provides flexibility in scheduling in multiple ways, e.g., this will enable:
Efficient scheduling of correlated DL and UL traffic pattern, where UL transmission depends on previous DL transmission or vice-versa and thus both can be scheduled by a single DCI,
flexible configuration of grants where a grant can be utilized for data transmission or control information transmission,
curtailing of DCI usage as different types of grants can be allocated using one DCI which result in less PDCCH resource usage and less UE complexity in monitoring fewer PDCCH candidates and/or
faster allocations as multiple allocations can be granted at once within short span as opposed to consecutive allocations procedure.

According to some other embodiments of inventive concepts, scheduling methods may be provided where two or more allocations are correlated with some transmissions or are used for correlated transmissions, e.g., some allocations are dependent on the other transmissions or some transmissions over some allocations are dependent on the other transmissions over the other allocations.

According to some embodiments of inventive concepts, at least one of the one or more control channel allocations for DL and/or UL and the one or more of the DL dynamic shared channel allocations and/or DL SPS and/or UL dynamic share channel allocations and/or UL CG allocations has a dependency on at least one other of the one of the one or more control channel allocations for DL and/or UL and the one or more of the DL dynamic shared channel allocations and/or DL SPS and/or UL dynamic share channel allocations and/or UL CG allocations.

According to other embodiments of inventive concepts, the dependency is indicated. In some of these other embodiments, the indicating indicates that a resource allocation of a later transmitted of the one of the one or more control channel allocations for DL and/or UL and the one or more of the DL dynamic shared channel allocations and/or DL SPS and/or UL dynamic share channel allocations and/or UL CG allocations depends on an outcome of an earlier transmitted of the one of the one or more control channel allocations for DL and/or UL and the one or more of the DL dynamic shared channel allocations and/or DL SPS and/or UL dynamic share channel allocations and/or UL CG allocations.

In some other of these embodiments of inventive concepts, the indicating indicates that transmission parameters of the later transmitted of the one of the one or more control channel allocations for DL and/or UL and the one or more of the DL dynamic shared channel allocations and/or DL SPS and/or UL dynamic share channel allocations and/or UL CG allocations depends on an outcome of an earlier transmitted of the one of the one or more control channel allocations for DL and/or UL and the one or more of the DL dynamic shared channel allocations and/or DL SPS and/or UL dynamic share channel allocations and/or UL CG allocations.

In yet other embodiments of these embodiments of inventive concepts, indicating the dependency indicates that at a later transmitted of the one of the one or more control channel allocations for DL and/or UL and the one or more of the DL dynamic shared channel allocations and/or DL SPS and/or UL dynamic share channel allocations and/or UL CG allocations is indicated by flag information included in an earlier transmitted of the one of the one or more control channel allocations for DL and/or UL and the one or more of the DL dynamic shared channel allocations and/or DL SPS and/or UL dynamic share channel allocations and/or UL CG allocations.

According to some embodiments of additional embodiments of inventive concepts, the dependency is derived from transmission parameters. In other embodiments of these additional embodiments, the dependency is determined based on decoding of an earlier transmission where the dependency is derived based on the earlier transmission.

In further embodiments of inventive concepts, the single DCI dynamically configures the one of the one or more control channel allocations for DL and/or UL and the one or more of the DL dynamic shared channel allocations and/or DL SPS and/or UL dynamic share channel allocations and/or UL CG allocations.

In yet further embodiments of inventive concepts, the one of the one or more control channel allocations for DL and/or UL and the one or more of the DL dynamic shared channel allocations and/or UL dynamic share channel allocations are periodically configured.

In other embodiments of inventive concepts, HARQ feedback is sent of SPS allocation in CG occasions in UL, where SPS and CG are both allocated by a same DCI.

In some other embodiments of inventive concepts, the radio access node schedules, via the single DCI, one or more of UL uplink control information, UCI, hybrid automated repeat request, HARQ, channel status information, CSI, and a scheduling request, SR.

According to further embodiments of inventive concepts, the radio node schedules, via the single DCI, one or more of UL uplink control information, UCI, hybrid automated repeat request, HARQ, channel status information, CSI, and a scheduling request, SR.

According to additional embodiments of inventive concepts, determining the single DCI includes stacking two legacy DCIs and one common cyclic redundancy check, CRC.

According to yet further embodiments of inventive concepts, the parameters for the one or more control channel allocations and the one or more of the DL dynamic shared channel allocations and/or the UL dynamic shared channel allocations includes one or more of:
a pointer measured from a PDSCH to a physical uplink control channel, PUCCH, carrying HARQ-ACK codebook,
a pointer measured from PDCCH carrying the single DCI to physical uplink shared channel, PUSCH, allocation, and
a pointer measured from PDSCH to PUSCH carrying data or HARQ codebook or both data and HARQ codebook.

According to yet other embodiments of inventive concepts, the parameters for the one or more control channel allocations and the one or more of the DL dynamic shared channel allocations and/or the UL dynamic shared channel allocations includes one or more of.
multiple pointers for multiple allocations;
pointers to channels over which feedbacks or HARQ-ACK codebooks are transmitted for some other channels; and
pointers with respect to different channels.

According to some other embodiments of inventive concepts, the single DCI indicates that a transmission over a DL shared channel is subject to one of a partially or fully successful transmission over a UL shared channel or a partially or fully failed transmission over the UL shared channel.

According to still other embodiments of inventive concepts, the single DCI indicates that a transmission over the UL shared channel is subject to one of a partially or fully successful transmission over the DL shared channel or a partially or fully failed transmission over the DL shared channel.

Radio access nodes, computer programs and computer program products that perform analogous embodiments are also provided.

According to other embodiments of inventive concepts, a method performed in a user equipment, UE, includes receiving a single downlink control information, DCI, that schedules one or more control channel allocations and any combination of one or more DL and/or UL control channel allocations, and/or one or more of dynamic DL shared channel allocations and/or one or more DL semi-persistent scheduling, SPS, allocations and/or one or more dynamic UL shared channel allocations, and/or one or more UL configured grant, CG, allocations, and/or one or more DL shared channel allocations comprising or multiplexed with control information and/or UL shared channel allocations comprising or multiplexed with control information. The method includes transmitting one or more of UL control information and UL data, and/or UL data and DL data, and/or DL data and UL control information in accordance with the single DCI.

According to some embodiments of inventive concepts, transmitting one or more of UL control information, UL data and DL data in accordance with the single DCI includes responsive to the DCI scheduling multiple grants corresponding to a physical uplink shared channel, PUSCH allocation for UL data transmission, and/or physical uplink control channel, PUCCH, allocation for power reporting: transmitting UL data transmission on the PUSCH and/or reporting power information on the PUCCH or in UL HARQ feedback, or UCI or in scheduling requests or in CG-UCI.

According to some embodiments of inventive concepts, transmitting one or more of UL control information, UL data and DL data in accordance with the single DCI includes responsive to the DCI scheduling multiple grants corresponding to a physical uplink shared channel, PUSCH, allocation for DL data transmission, and/or physical downlink control channel, PDCCH allocation for reporting feedback, and/or DFI, and/or a DCI indication, and/or a preemption command, and/or a cancellation command, and/or scheduling parameters: transmitting DL data transmission on the physical downlink shared channel, PDSCH.

According to yet other embodiments of inventive concepts, transmitting one or more of UL control information, UL data and DL data in accordance with the single DCI includes responsive to DL resource allocation and UL resource allocation is scheduled in the single DCI: generating specific UL data and transmitting specific UL data using the UL resource allocated only if DL physical downlink shared channel, PDSCH is decoded successfully; or generating specific DL data and transmitting specific DL data using the DL resource allocated only if UL physical uplink shared channel, PUSCH, is decoded successfully.

According to further embodiments of inventive concepts, the single DCI schedules multiple UL and DL transmissions where some parameters of the UL transmissions are derived from flag information which is multiplexed with associated DL transmission.

According to additional embodiments of inventive concepts, the UE, responsive to the single DCI scheduling a pair of UL and DL transmissions, obtains from the single DCI one or more of:
a same hybrid automatic repeat request, HARQ, process ID;
a same modulation and coding scheme, MCS, scheme;
a same priority;
a same reliability target;
a same latency budget;
a same redundancy value, RV, id or RV sequence;
a same Carrier id;
a same bandwidth part, BWP, id; and/or
a same new data indicator, NDI.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of dynamic DL scheduling;

FIG. 2 is an illustration of DL SPS scheduling;

FIG. 3 is an illustration of dynamic UL scheduling;

FIG. 4 is an illustration of UL CG activation scheduling;

FIG. 5 is an illustration of an example of DL and UL resource allocation;

FIG. 6 is an illustration of an example of a transmission timeline;

FIG. 7 is an illustration of dynamic PUSCH and/or UL scheduling in LTE or NR;

FIG. 8 is an illustration to control a maximum number of AUL retransmissions using CGT;

FIG. 9 is a block diagram illustrating DCI scheduling both DL and UL according to some embodiments of inventive concepts;

FIG. 10 is a block diagram illustrating HARQ-ACKs of multiple PDSCHs that are transmitted over PUSCH or PUCCH which is also allocated by the same DCI as for multiple PDSCHs according to some embodiments of inventive concepts;

FIG. 11 is a block diagram illustrating a single DCI allocating a plurality of grants where the grants can be numbered where HARQ-ACKs of multiple PDSCHs can indicated to be transmitted in which UL grant, e.g., the HARQ-ACKs of PDSCH #1 and PDSCH #2 are to be transmitted in PUSCH #2, and the HARQ-ACKs of PDSCH #3 and PDSCH #4 are to be transmitted in PUSCH #4 according to some embodiments of inventive concepts;

FIG. 12 is a block diagram illustrating a single DCI activating an SPS and CG where UL data and HARQ-ACK of an PDSCH can be sent in UL occasion of a CG distanced at Kx according to some embodiments of inventive concepts;

FIG. 13 is a block diagram illustrating an activation DCI activating a single SPS configuration according to some embodiments of inventive concepts;

FIG. 14 is a block diagram illustrating a DCI scheduling PDSCH and partially PUCCH, where a flag information is multiplexed onto the PDSCH according to some embodiments of inventive concepts;

FIG. 15 is a block diagram illustrating a DCI pointing to DL PDSCH allocation, where the PDSCH is multiplexed with another DCI that points to PUSCH allocations for data and HARQ-ACK transmission of the PDSCH according to some embodiments of inventive concepts;

FIG. 16 is a block diagram illustrating a wireless device UE according to some embodiments of inventive concepts;

FIG. 17 is a block diagram illustrating a radio access network RAN node (e.g., a base station eNB or gNB) according to some embodiments of inventive concepts;

FIG. 18 is a block diagram illustrating a core network CN node (e.g., an AMF node, an SMF node, etc.) according to some embodiments of inventive concepts;

FIGS. 19-24 are flow charts illustrating operations of a radio access node of a wireless network according to some embodiments of inventive concepts;

FIG. 25 is a flow chart illustrating operations of a user equipment, UE, according to some embodiments of inventive concepts;

FIG. 26 is a block diagram of a communication system in accordance with some embodiments;

FIG. 27 is a block diagram of a user equipment in accordance with some embodiments;

FIG. 28 is a block diagram of a network node in accordance with some embodiments;

FIG. 29 is a block diagram of a host computer communicating with a user equipment in accordance with some embodiments;

FIG. 30 is a block diagram of a virtualization environment in accordance with some embodiments; and

FIG. 31 is a block diagram of a host computer communicating via a base station with a user equipment over a partially wireless connection in accordance with some embodiments in accordance with some embodiments.

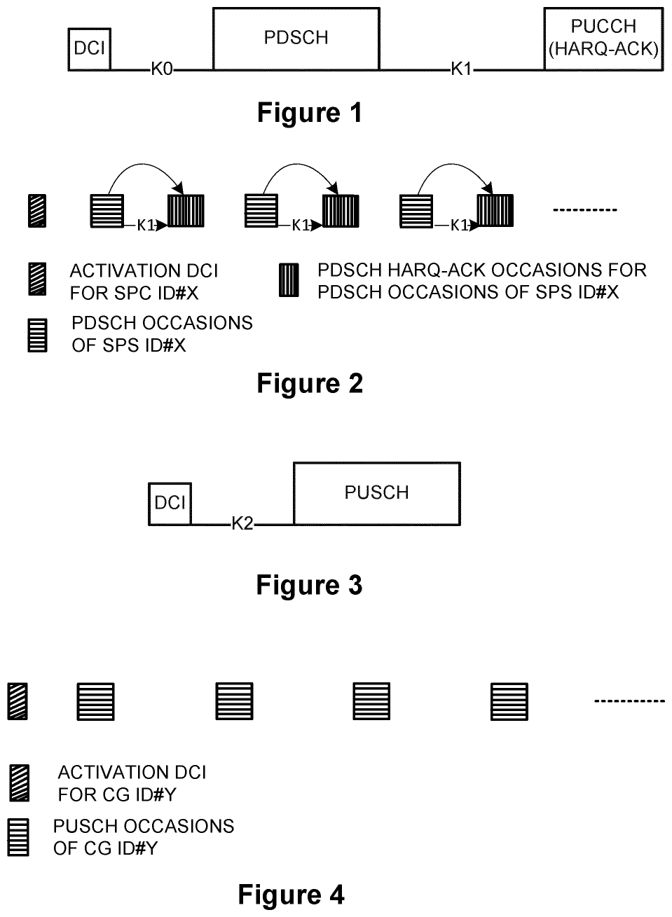

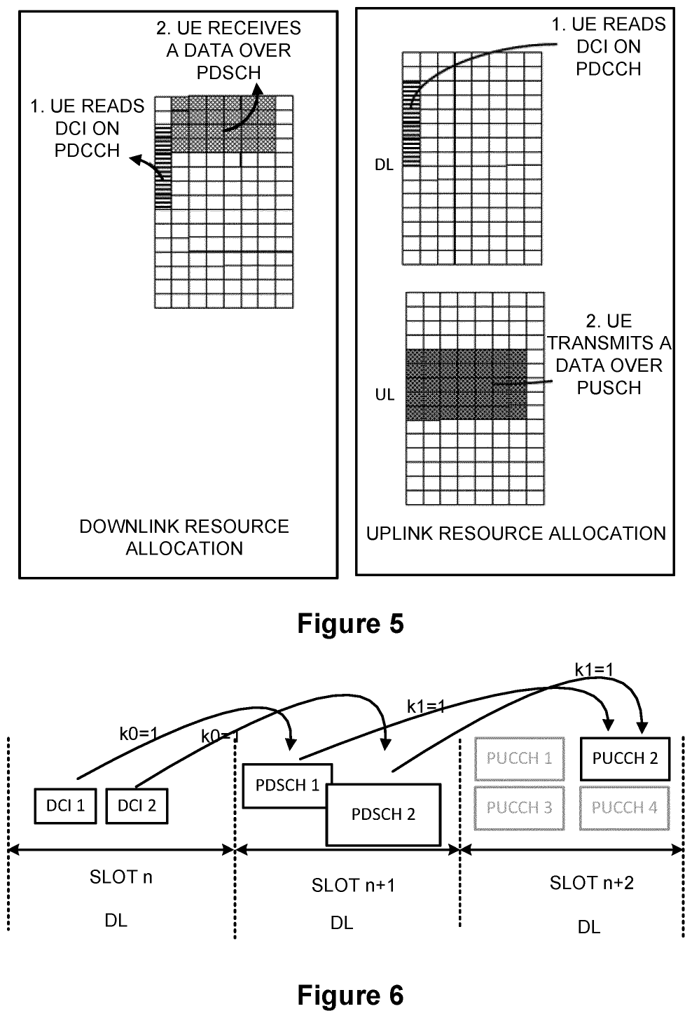

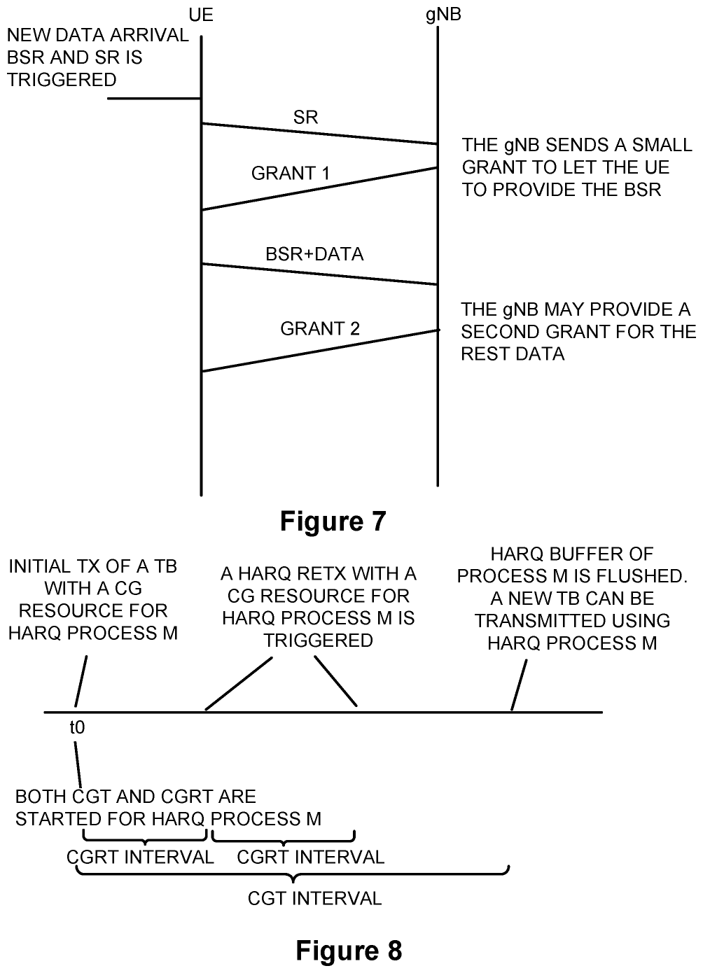

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present or used in another embodiment.

In the description that follows, the various embodiments can be utilized for any generation of wireless technologies including operation in both licensed and unlicensed spectrum, or time-division duplexing (TDD) and frequency-division duplexing (FDD) operation, etc. As used herein, K0 is a pointer which can be assumed in slots, sub-slots, measured from PDCCH carrying DCI to PDSCH allocation. K1 is a pointer which can be assumed in slots, sub-slots, or symbols, measured from PDSCH to PUCCH carrying HARQ-ACK codebook. K2 is a pointer which can be assumed in slots, or symbols, measured from PDCCH carrying DCI to PUSCH allocation.

The inventive concepts that provide some solutions to the constraints of legacy scheduling focus on new type of scheduling design using a single DCI where it is not constrained by the legacy scheduling. They include new scheduling methods which can e.g. provide plurality of grants, e.g., mix of DL and UL grants, plus control channel allocation where these mix of allocations or grants or assignments have some sort of dependency.

A single DCI (over PDCCH) that can schedule any non-limiting combination of the following to a UE:
One or more UL dynamic shared channel allocations (prior-art)
One or more DL dynamic shared channel allocations (prior-art)
One or more of UL CG allocations (prior-art)
One or more of DL SPS allocations (prior-art)One PDSCH and one PUSCH (prior-art)
One or more of control channel allocations (UCI, HARQ, CSI, SR) pa UL plus CSI (PUSCH), DL plus HARQ (PUCCH)
Multi-PUSCH and multi-PDSCH
Combinations of above, e.g., mix of
   1. UL allocation (single or multi-PUSCH or UL CG) and/or
   2. DL allocations (single or multi-PUSCH or DL SPS) and/or
   3. control channel (UCI, e.g., HARQ feedback, CSI, SR, and/or DCI, e.g., scheduling DCI, DFI, feedback)
      It is noted that the terminology “activate an allocation” can be used in replacement of scheduling an allocation in case of periodic allocation like SPS allocation or semi-static allocation.

When we have combinations or a mix or a set of allocations (from shared and control channel types) which are allocated by a single DCI, then these mix of grants or assignments or allocations are dependent. For example:
if a shared channel grant or assignment, or control channel (from the set) is transmitted or received then, for e.g., the successive transmission, e.g., next shared channel grant or assignment, or control channel (from the remining set) will depend on previous transmission
   Assuming two allocations, say UL PUSCH and DL PDSCH scheduled where PDSCH allocation follows the PUSCH
      If PUSCH is decoded by gNB, gNB then transmits over PDSCH with certain transmission characteristics or certain utilization (e.g., use full PDSCH)
         If PUSCH is not decoded by gNB, gNB then transmits over PDSCH with different transmission characteristics or different utilization (use partial PDSCH or none

Moreover, some of the inventive concepts teach “new” scheduling methods where the two or more allocations are correlated with some transmissions or are used for correlated transmissions, e.g., some allocations are dependent on the other transmissions or some transmissions over some allocations are dependent on the other transmissions over the other allocations.

### Use Cases

Below are uses cases which depicts interactive traffic where UL and DL traffic can be dependent
1. In XR, DL data transmission can depend on UL data transmissions (verbal communication from XR delegates)
2. In LS 5G-ACIA to 3GPP (LS5G-ACIA, “LS on 3GPP NR Rel-16 URLLC and IIoT performance evaluation,” LS 5G-ACIA-LS-2020-WI042, 26 Jun. 2020), in Sec 5.2.7, they mentioned a scenario with DL-UL relationship, where it is mentioned:
   “For DL-UL traffic arrival time relationship, two options can be considered as follows.
   . . .
   Option-2: UL traffic arrives at some pre-defined x time duration, where x can be, e.g., half of transfer interval, after the respective DL traffic arrival time.”
3. In TS22.104, we have use case related to motion control which depicts interactive traffic, it is mentioned
“Use cases one to three
Characteristic parameters and influence quantities for a communication service supporting the cyclic interaction described above.”

As previously indicated, various embodiments of inventive concepts enable multiple allocations or transmission granted to a UE by using a single DCI. This provides flexibility in scheduling in multiple ways, e.g., this will enable
Efficient scheduling of correlated DL and UL traffic pattern, where UL transmission depends on previous DL transmission or vice-versa and thus both can be scheduled by a single DCI.
Flexible configuration of grants where a grant can be utilized for data transmission or control information transmission
Curtailing of DCI usage as different types of grants can be allocated using one DCI which result in less PDCCH resource usage and less UE complexity in monitoring fewer PDCCH candidates
Faster allocations as multiple allocations can be granted at once within short span as opposed to consecutive allocations procedure

### Single DCI Scheduling Multiple Non-Limiting DL and UL Allocations

In some embodiment of inventive concepts, a DCI (e.g., transmitted on PDCCH) schedules simultaneously multiple DL and UL transmissions in any order where DL and UL transmissions can be any of physical shared channels, physical control channels, and/or physical signals. Note that physical shared channels, control channels, and signal can include among other things PDSCH, PUSCH, PDCCH, PUCCH, PRACH, CSI-RS, SRS, SSB. Some examples are where a single DCI (over PDCCH):
Is a form of activation DCI which allocates a DL SPS and an UL CG. To active an SPS and a CG, two separate activation DCIs are used in some embodiments.
A DCI allocates a PUSCH for CSI reporting and updates the power of an existing allocated CG.
Provides updates on existing allocations pertaining to ongoing or anticipated HARQ processes in UL and/or DL,
Other procedures which are not involved directly to data transmission grant, e.g., transmission of TA command, transmission of slot format indicator (SFI), etc. For example, a DCI provides multiple grants corresponding to PDSCH allocation (for reception of TA command in the form of MAC CE), a PUSCH allocation (for UL data transmission), PDCCH allocation (for reception of SFI), PUCCH allocation (for power reporting from UE).

The DL and/or UL transmissions can be dynamically scheduled or semi-statically configured. In the case of semi-static configuration, the DCI is considered to activate these DL and/or UL transmissions.

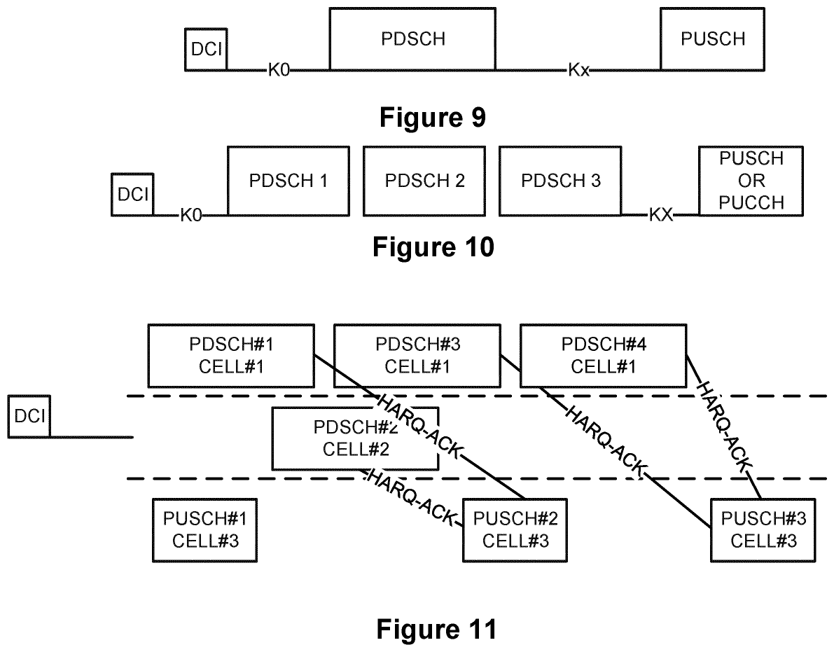

FIG. 9 illustrates an example of a single DCI scheduling DL and UL data transmission by providing DL allocation for PDSCH and UL allocation for PUSCH. The single DCI contains:
Time and frequency domain resource allocation information of PDSCH, as well as other parameters related to PDSCH such as MCS, HARQ feedback timing (PDSCH-to-HARQ_feedback timing indicator), etc., and
Time and frequency domain resource allocation information of PUSCH, as well as other parameters related to PUSCH such as MCS, power control, etc.
The pointer (Kx) (shown in FIG. 9 pointing to PUSCH allocation) can be mentioned in the DCI directly, or by mapping with RRC table, e.g., the Kx pointer field in DCI index to a row of RRC table (containing rows where each row represent a Kx value or function of Kx). However, there could be multiple variations of Kx regarding its reference point, e.g.,
   The pointer Kx can be with respect to PDSCH, or
   The pointer Kx can be with respect to the DCI

FIG. 10 illustrates an example where a DCI schedules multiple allocated PDSCHs, and an UL resource, where the UL allocation can be sued for UL shared channel (PUSCH) or control channel (PUCCH). Thus, HARQ-ACKs of multiple PDSCHs may be transmitted over PUSCH or PUCCH which is also allocated by the same DCI as for multiple PDSCHs.

Currently, for PDSCH allocation, a DCI indicates PDSCH-to-HARQ_feedback timing (called also K1 value) which is a pointer from DL grant pointing to UL resource (PUCCH) where HARQ-ACK for the DL transmission is transmitted over PUCCH. The example illustrated in FIG. 10 can be extended to a plurality of UL and DL grants as illustrated in FIG. 11.

In FIG. 11, a DCI is illustrated allocating a plurality of grants. Further, the grants can be numbered where HARQ-ACKs of multiple PDSCHs can indicated to be transmitted in which UL grant, e.g., the HARQ-ACKs of PDSCH #1 and PDSCH #2 are to be transmitted in PUSCH #2, and the HARQ-ACKs of PDSCH #3 and PDSCH #4 are to be transmitted in PUSCH #4. Besides, PUSCHs can carry UL data along with HARQ-ACKs. The overlapping PDSCHs for instance, can be allocated in different cells using the same DCI.

Currently, for PDSCH allocation, a DCI indicates PDSCH-to-HARQ_feedback timing (called also K1 value) which is a pointer from DL grant pointing to UL resource (PUCCH) where HARQ-ACK for the DL transmission is transmitted over PUCCH. However, the UL allocation is not necessarily limited to PUCCH resource for only HARQ-ACK transmission. The proposed UL allocation can be used by UE in the following ways:
UE can transmit UL data
UE can transmit UL control information
   HARQ-ACK for the DL transmission allocated with same DCI as for PUSCH
   HARQ-ACK for some other DL transmission which is allocated with some other DCI
   CSI reporting
   One-bit SR or Multi-bit SR
   BSR (currently BSR is a MAC CE and transmitted over PUSCH, here we assume BSR can be treated as UCI)
UE can transmit multiplexing of the above options, e.g., HARQ-ACK and UL data, or HARQ-ACK and BSR

In the example illustrated in FIG. 10, if PUSCH is allocated, then the resource allocated can be used to transmit UL data and/or HARQ-ACK feedback of PDSCHs, e.g., of PDSCH 1 to PDSCH 3. Otherwise, if the UL resource is configured as PUCCH, then it can be used to transmit HARQ-ACK feedback of PDSCHs, e.g., of PDSCH 1 to PDSCH 3.

In various embodiments of inventive concepts, the meaning of the field PDSCH-to-HARQ_feedback timing indicator (K1) in the DCI changes dynamically depending on a new DCI field which indicates what kind of transmission is expected after K1 time offset. This new DCI field can be called “Offset transmission type”. As one example, if the field is 1-bit long, “0” value can indicate legacy HARQ-ACK transmission, while “1” can indicate PUSCH transmission or PUSCH+UCI. Other combinations or meanings are not precluded. Another example can be given for a longer field, as shown in Table 2 when “Offset transmission type” is 2-bits long.

TABLE 2a
New DCI field “Offset transmission type” meaning

| Field value | Transmission type |
|---|---|
| 00 | HARQ-ACK (legacy case) |
| 01 | PUSCH |
| 10 | PUSCH + HARQ-ACK |
| 11 | PUSCH + HARQ-ACK + CSI |

In another scenario, opposite of the Table 1a scenario, where DCI allocated a PUSCH and subsequent PDSCH. In PDSCH, we can send data, DFI (feedback for PUSCH), BSR and SR (any combination), one example is presented in the form of Table 1b

TABLE 2b
New DCI field “Offset transmission type” meaning

| Field value | Transmission type |
|---|---|
| 00 | DFI |
| 01 | PDSCH |
| 10 | PDSCH + SR |
| 11 | PDSCH + DFI + SR |

Using the example from Table 2, if Offset transmission type=“01”, then PDSCH-to-HARQ feedback timing indicator will now be used as PDSCH-to-PUSCH timing indicator or DCI to PUSCH timing indicator (K2). Similarly, if Offset transmission type=“10”, then PDSCH-to-HARQ feedback timing indicator will now be used as PDSCH-to-PUSCH-and-HARQ_feedback timing indicator.

As an alternative to the above embodiment, Offset transmission type can be incorporated in a PDSCH-to-HARQ feedback timing indicator table such that each row should additionally have transmission type information. Example can be given in Table 3 below (similarly to Table 9.2.3-1 in 3GPP TS 38.213 v.16.3.0). In the below example, in the resource allocation DCI, the indicated value either allocates PUCCH for HARQ-ACK transmission at slot k1 with respect to PDSCH or allocates PUSCH at slot k3 with respect to PDSCH.

TABLE 3
Example of mapping of PDSCH-to-HARQ_feedback timing
indicator field values to numbers of slots and transmission
type when indicator field is 3-bits long

| PDSCH-to- | | |
|---|---|---|
| HARQ_feedback timing | Transmission | |
| indicator | type | Number of slots k |
| ‘000’ legacy | HARQ-ACK | 1st value provided by dl- |
| | | DataToUL-ACK or by dl- |
| | | DataToUL- |
| | | ACKForDCIFormat1_2 |
| ‘001’ legacy | HARQ-ACK | 2nd value provided by dl- |
| | | DataToUL-ACK or by dl- |
| | | DataToUL- |
| | | ACKForDCIFormat1_2 |
| ‘010’ legacy | HARQ-ACK | 3rd value provided by dl- |
| | | DataToUL-ACK or by dl- |
| | | DataToUL- |
| | | ACKForDCIFormat1 2 |
| ‘011’ legacy | HARQ-ACK | 4th value provided by dl- |
| | | DataToUL-ACK or by dl- |
| | | DataToUL- |
| | | ACKForDCIFormat1 2 |
| ‘100’ extended | PUSCH | 1st value provided by dl- |
| | | DataToUL-ACK or by dl- |
| | | DataToUL- |
| | | ACKForDCIFormat1_2 |
| ‘101’ extended | PUSCH | 2nd value provided by dl- |
| | | DataToUL-ACK or by dl- |
| | | DataToUL- |
| | | ACKForDCIFormat1 2 |
| ‘110’ extended | PUSCH | 3rd value provided by dl- |
| | | DataToUL-ACK or by dl- |
| | | DataToUL- |
| | | ACKForDCIFormat1 2 |
| ‘111’ extended | PUSCH | 4th value provided by dl- |
| | | DataToUL-ACK or by dl- |
| | | DataToUL- |
| | | ACKForDCIFormat1_2 |

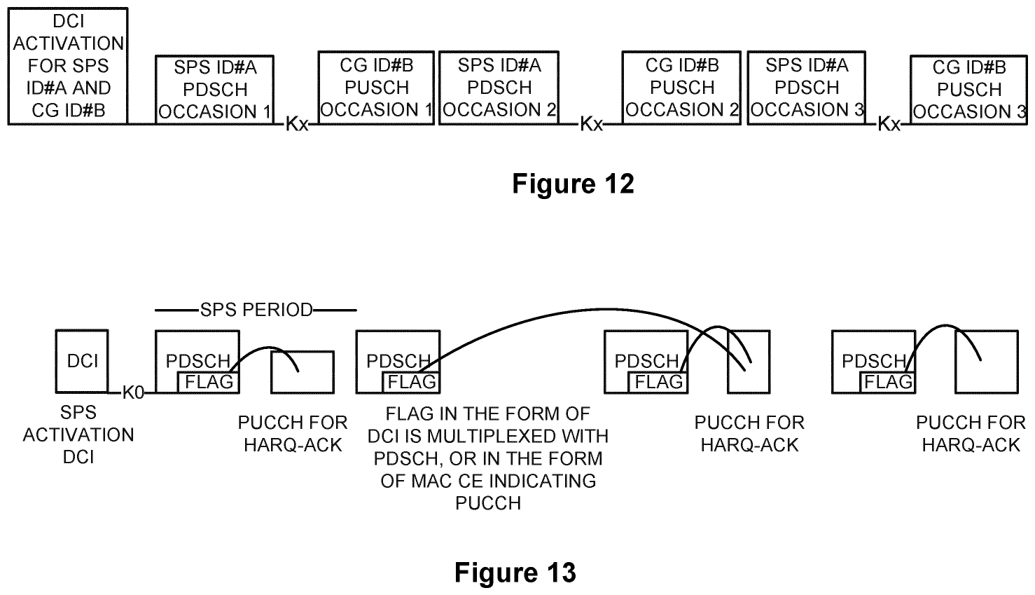

FIG. 12 illustrates a further example where a single DCI activates DL SPS and/or UL CG where UL data and HARQ-ACK of a PDSCH can be sent in a UL occasion of a CG distanced at Kx.

In the example of FIG. 11, a DCI could be an activation DCI that can activate DL SPS and/or UL CG. The DCI can contain information related to resource allocations of SPS and CG occasions as well as some timing parameters such as SPS and/or CG and/or pointer Kx. Similarly, the CG occasions depicted in FIG. 11 can (a) carry UL data only or (b) both UL data and HARQ-ACK of the PDSCH which points to the PUSCH, i.e., HARQ-ACK feedback of SPS PDSCH occasion 1 goes to CG occasion 1 alongside UL data (if there is UL data in the UE buffer). The transmission on successive CG PUSCH (at slot Kx with respect to SPS's PDSCH) can be dependent on SPS PDSCH's decoding. See different options in Table 4a and 4b as described below.

In a further extension, a gNB uses a single DCI to activate N SPS allocations (IDs) and M CG allocations (IDs), where for subset n1 out of N SPS IDs, their HARQ-ACK transmission is mapped to a given CG ID. This means, the given CG ID's occasions carry HARQ-ACKs of PDSCH occasions from n1 SPS IDs subset. The CG occasion in addition can also carry data.

In further variations of the above examples regarding the order of DL and UL transmissions, the following can also be considered:
UL transmission such as PUSCH or PUCCH is scheduled first and followed by DL transmission such as PDSCH
all transmissions are DL transmissions such as PDSCH
all transmissions are UL transmissions such as PUCSH and/or PUCCH allocations
First is PUSCH allocation and followed by PDCCH, where in PDCCH, UE may receive feedback for the PUSCH transmission from gNB or some other DL control information
   Dependency Between Multiple Scheduled Allocations and/or Transmissions

In the various embodiments of inventive concepts described above, DL and UL transmission scheduled or activated, respectively, by a DCI can be related to:
a single HARQ process, e.g., both UL and DL transmissions tied to a single HARQ process ID, or
same service, e.g., both are URLLC (ultra-reliable low-latency communication) transmission, or
correlated event, or
uncorrelated, different HARQ processes, services, or actions

In various other embodiments of inventive concepts, different scheduling solutions for cases where DL and UL transmission can be correlated or dependent on each other.

In some of these various other embodiments, if a UE is scheduled by a single DCI a pair of DL and UL allocation, e.g., PDSCH and PUSCH allocation as shown in FIG. 9, the PUSCH can be used to transmit UL data and/or UCI transmission. In this case, the UCI can, e.g., be related to ongoing transmissions, i.e., PDSCH, PUSCH, etc. For example, the UCI can contain HARQ-ACK of PDSCH or the UCI can contain some parameters to decode PUSCH, e.g., the UCI can indicate RV pattern, MCS of PUSCH if the UE is allowed to choose.

Further, a special use case shall be described, where PUSCH is allocated to transmit UL data as well as HARQ-ACK feedback for the received PDSCH. Two sub-use cases is described where the UL data transmission on PUSCH is subject to successful decoding of PDSCH, i.e., anew kind of interactive traffic scenario, where UE generates UL data subject to DL data, see Table 4a for various possibilities on transmission on PUSCH.

TABLE 4a
Two broad scenarios where UL traffic generated
subject to DL traffic where both DL and UL resource
allocation scheduled by using single DCI

| UL traffic | | |
|---|---|---|
| generation | PDSCH | |
| scenario | decoded | UE transmits in PUSCH |
| PDSCH reception | No | UL data, and |
| and subsequent UL | | HARQ-ACK feedback of PDSCH |
| data (PUSCH or | | indicating NACK |
| UL TB) | Yes | UL data, and |
| transmission are | | HARQ-ACK feedback of PDSCH |
| independent | | indicating ACK |
| UL data (or | No | No UL data (it's indicative NACK for |
| particular UL TB) | | PDSCH, thus no need to send HARQ- |
| is generated only if | | ACK indicating NACK), i.e., skip UL |
| DL PDSCH is | | The UE transmits NACK |
| decoded | | UE sends UL data (TB#1), an UL TB with |
| successfully | | particular characteristics indicate PDSCH |
| | | is not decoded, e.g., TB#1 is smaller than |
| | | TB#2 (see below ‘Yes’ part for TB#2 |
| | | reference) |
| | | Any combination of above |
| | Yes | UL data (TB#2) (it's indicative of ACK |
| | | for PDSCH, thus no need to send HARQ- |
| | | ACK indicating ACK) |
| | | Skip UL |
| | | UE sends ACK |
| | | Any combination of above |

In another case, a scenario is defined where DL (PDSCH transmission) is dependent or not on UL (PUSCH transmission), see Table 4b.

TABLE 4b
Two broad scenarios where DL traffic generated subject
to UL traffic where both UL and DL resource allocation
scheduled by using single DCI (i.e., a DCI allocates
a PUSCH and PDSCH where PDSCH is allocated in future
(farther in time) with respect to PUSCH)

| DL traffic | | |
|---|---|---|
| generation | PUSCH | |
| scenario | decoded | gNB transmits in PDSCH |
| PUSCH reception | No | DL data (PDSCH or DL TB), and |
| and subsequent | | HARQ-ACK feedback of PUSCH |
| UL data | | indicating NACK (or DFI indicating |
| transmission | | NACK for PUSCH) |
| are independent | Yes | DL data, and |
| | | HARQ-ACK feedback of PDSCH |
| | | indicating ACK (or DFI indicating |
| | | ACK for PUSCH) |
| Subsequent DL | No | No DL data (it's indicative NACK for |
| data (or particular | | PUSCH, thus no need to send HARQ- |
| DL TB) is | | ACK/DFI indicating NACK), i.e., skip DL |
| generated only if | | The gNB transmits NACK (e.g., on DFI |
| UL PUSCH is | | on PDSCH) |
| decoded | | gNB sends DL data (TB#1), a DL TB with |
| successfully | | particular characteristics indicating |
| | | PUSCH is not decoded, where e.g., TB#1 |
| | | is smaller than TB#2 (see below ‘Yes’ part |
| | | for TB#2 reference) |
| | | Any combination of above |
| | Yes | DL data (TB#2) (it's indicative of ACK for |
| | | decoded PUSCH, thus no need to send |
| | | HARQ-ACK and/or DFI indicating ACK) |
| | | Skip DL |
| | | gNB sends ACK (e.g., on DFI on PDSCH) |
| | | Any combination of above |

In some embodiments of inventive concepts, a single DCI schedules or activates, respectively, multiple dependent DL and UL transmissions where some parameters of the UL transmission are derived from a flag which is multiplexed with an associated DL transmission. Examples of the flag include:
In one version, the flag itself or the flag together with the outcome of DL reception at the UE selects the message to transmit in UL.
In another version, the flag itself or the flag together with the outcome of DL reception at the UE selects the resource to use for the corresponding UL transmission.
In yet another version, the flag itself or the flag together with the outcome of DL reception at the UE indicates certain UL transmission parameters such as those related to timing of the UL transmission, transmit power, MCS, etc.

A non-limiting example of the above flag embodiment shall now be described.

A DCI is transmitted over PDCCH which provides multiple PDSCH and PUCCH/PUCCH allocations. The PDSCH transmission contains DL data multiplexed with a flag information which can indicate/point to specific UL resource (PUSCH or PUCCH) and the related information for the transmission over this UL resource.

The DCI can indicate how and where over the PDSCH the flag is located or how it is multiplexed, so that UE can decode DL data and flag information which further affects the next UL transmission.

The flag information can be included in DL transmission (e.g., PDSCH) in different ways, e.g.,
1. as a part of DL data, e.g., based on MAC CEs, or
2. as a separate DCI (e.g., based on existing DCI format 0_1, 0_2, 0_3, 1_0, 1_1, 1_2, group-common formats, etc.) which is multiplexed onto PDSCH

One use of the above flag embodiment is when the DL transmissions correspond to DL SPS and the corresponding UL transmissions are HARQ-ACK in response to the SPS PDSCH.

For DL SPS, the HARQ-ACK is often sent in PUCCH in a slot indicated by a slot timing indicator in the activation DCI. Since only a single value of the slot offset timing indicator is indicated, in TDD scenarios, this can cause issues like collisions of PUCCHs carrying HARQ-ACK with invalid slots, e.g., DL slot/other transmissions, resulting in the PUCCH transmission being dropped. The root of this issue is the inflexibility of slot offset timing indicator for SPS HARQ-ACK which is fixed and indicated in the activation DCI only once which does not always match with the DL-UL slot pattern for all SPS occasions.

With the above embodiment, the SPS HARQ-ACK slot offset timing can be indicated through a flag information in PDSCH instead of only by the activation DCI. In one example, the DL SPS is activated by activation DCI (or via RRC) without HARQ-ACK slot timing indication. The slot timing of PUCCH carrying HARQ-ACK in response to each SPS PDSCH is included in a flag multiplexed in the PDSCH, see FIG. 13, which illustrates an example where an activation DCI activates a single SPS configuration. The figure depicts the first four SPS PDSCH occasions. When gNB transmits PDSCH, it also includes a flag indicating the slot timing for HARQ-ACK feedback in response to the transmitted PDSCH. In a further example, the DL SPS is activated by activation DCI (or via RRC) with HARQ-ACK slot timing indication. This slot timing indication is used whenever it corresponds to a valid slot, e.g., point to an UL slot. Otherwise, the slot offset timing of PUCCH carrying HARQ-ACK in response to each SPS PDSCH is determined from a flag multiplexed in the PDSCH instead.

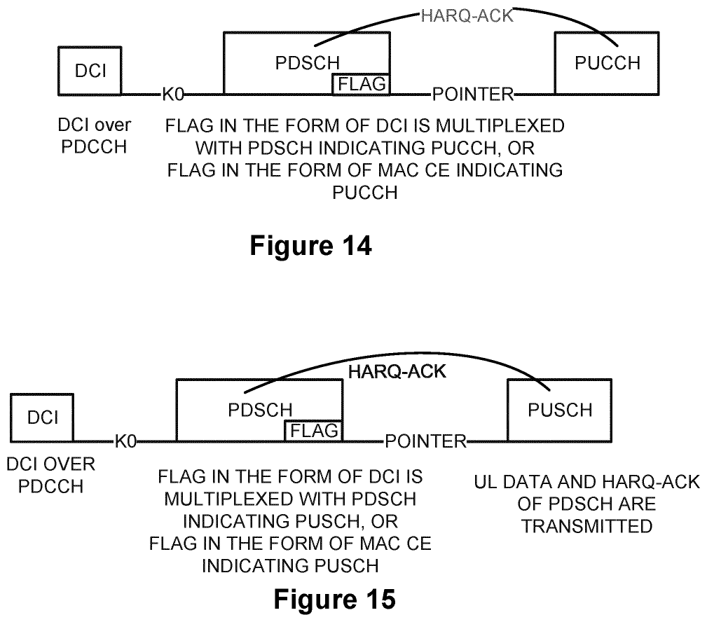

Another example of a use case is in dynamic scheduling of PDSCH and PUCCH. See FIG. 14, where A DCI schedules PDSCH and partially PUCCH, where a flag information is multiplexed onto the PDSCH. The flag information indicates slot offset timing of PUCCH carrying HARQ-ACK transmission in response to this PDSCH. Thus, a DCI schedules PDSCH and (partially) PUCCH, and the flag information is included in the PDSCH to provide additional information, e.g., related to the slot timing of the PUCCH resource. This use case can be relevant when PDSCH and PUCCH are supposed to be transmitted far in time with respect to the DCI, as it allows gNB more flexibility to control PUCCH transmission to avoid any potential conflict of PUCCH with other transmissions.

A related example is given in FIG. 15, where a DCI pointing to DL PDSCH allocation, where the PDSCH is multiplexed with another DCI that points to PUSCH allocations for data and HARQ-ACK transmission of this PDSCH. The flag information multiplexed with PDSCH provides information pertaining to where UL allocation for PUSCH is located, and potentially also how the UL data should be encoded and transmitted along with the HARQ-ACK for this PDSCH.

Note that in above examples, the PUCCH or PUSCH can be used for various kinds of UCI, e.g., one-shot HARQ-ACK, CSI, etc.

### Design of a Single DCI

A DCI scheduling one or more DL and UL transmissions described in the previous embodiments can be a new DCI format or can be composed of two or more existing DL and UL DCI formats.

Note that in some embodiments, if a single DCI schedules a pair of UL and DL transmissions, it can contain some common non-limiting parameters to be used for both UL and DL, e.g.,
Same HARQ process ID
Same MCS scheme, especially if it is the same carrier over TDD channel
Same priority
Same reliability target (coming from high layer parameters)
Same latency budget (coming from high layer parameters)
Same RV id or RV sequence
Same Carrier id
Same BWP id
Same NDI
Same Antenna port

In the case that, the single DCI is composed of two or more existing DL and UL DCI formats:
A new RNTI is used
DCI format 0_x can be stacked/combined with DCI format 1_y and only one cyclic redundancy check (CRC) scrambled with RNTI can be appended to provide DL and UL shared channel allocation
   Any combinations for stacking can be applied, e.g., DCI 0_x points to DL grant and DCI 1_y points to DL grant, or DCI 0_x points to DL grant and DCI 1_y points to UL grant, or DCI 0_x points to UL grant and DCI 1_y points to UL grant
Extending example of a, DCI format 0_x can be stacked with DCI format 1_y and both of their CRCs are combined (appended) and scrambled with RNTI
   For example, 8-bit CRC is generated for both scheduling DCIs, i.e., DCI format 0_x and DCI format 1_y, and their combined 16-bit CRC scrambled with 16-bit C-RNTI
In another example, the multi-TB scheduling can be done using single DCI carrying multiple DL grants or multiple UL grants or mix of DL and UL grants
Total number of stacked DCIs can be dynamic or fixed. Currently UE can monitor for 3+1 DCI sizes, but for stacked DCI this rule should be extended, such that 3 (for DCIs with C-RNTI)+1 (for DCI with other RNTI)+S (stacked DCI).
   “S” can be configured by higher layers.
   “S” can be limited by UE capability. Some UEs can support S=1 or 2 or more, thus, gNB cannot configure S to exceed indicated UE capability.
   For S number of monitored stacked DCIs, one should configure stack sets, e.g. if S=1, UE can be instructed to check for DCI 0_x+1_y; if S=2, UE can be instructed to check for DCI 0_x+1_y AND DCI 0_x+0_x etc.
   Alternatively, for S number of monitored stacked DCIs, UE can dynamically check DCIs combination depending on other signaling information, e.g. group common DL signaling, content of other DCI etc.

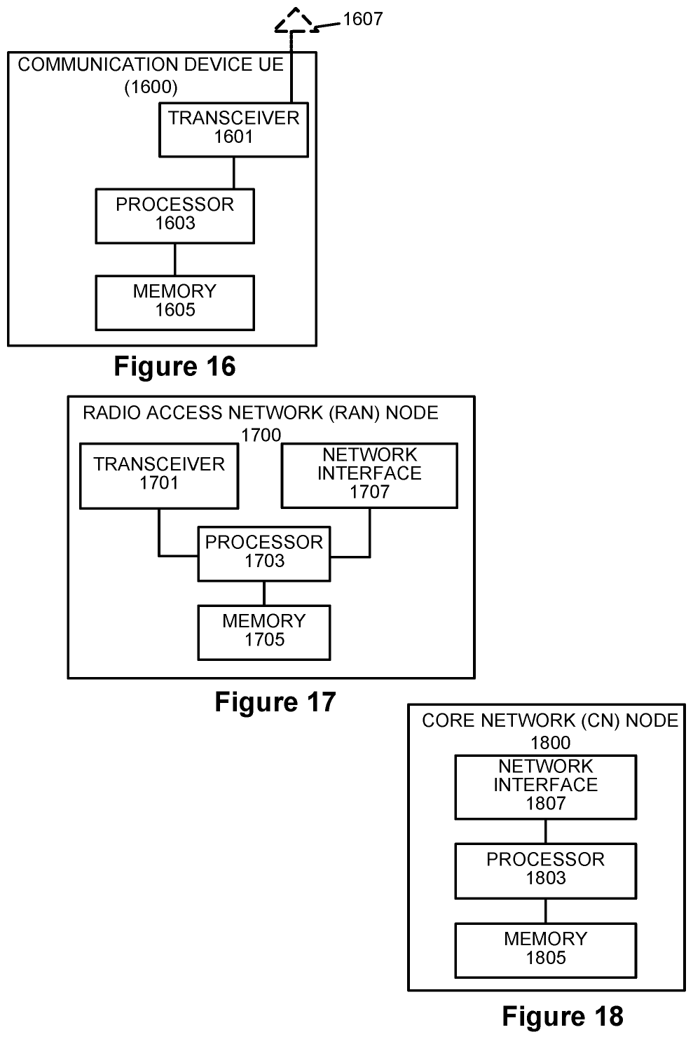

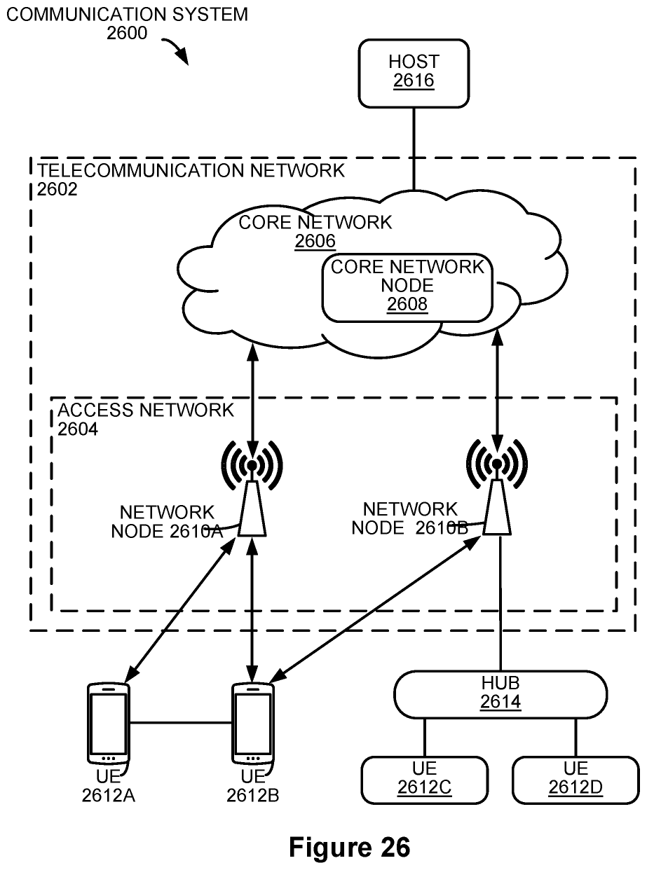

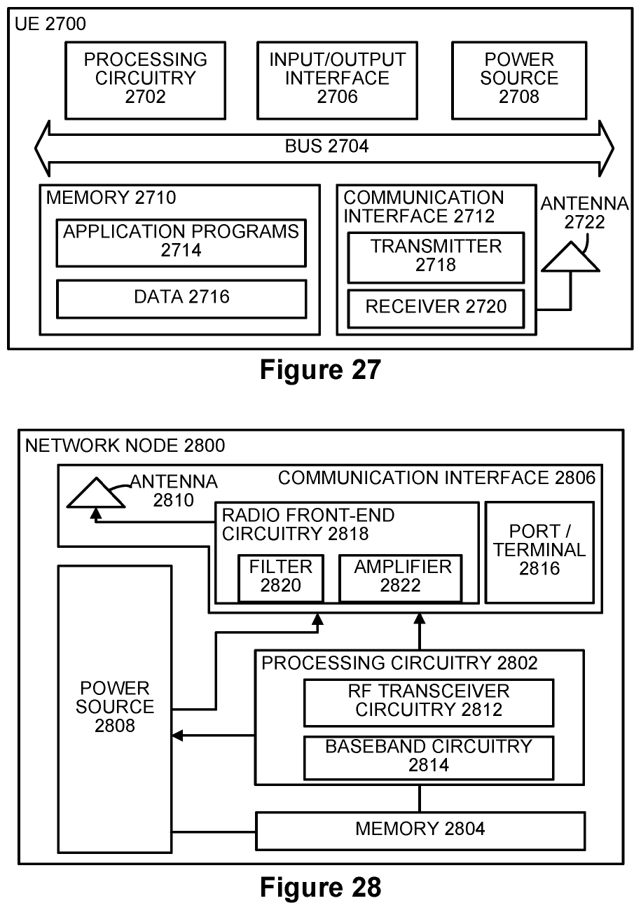

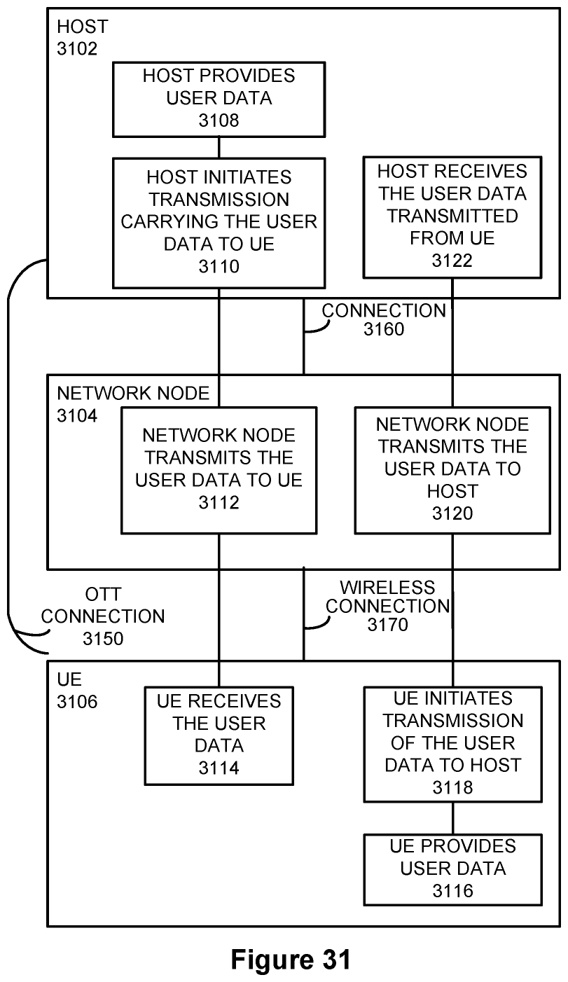

FIG. 16 is a block diagram illustrating elements of a wireless communication device UE 600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Wireless communication device 1600 may be provided, for example, as discussed below with respect to wireless devices UE 2612A, UE 2612B, and wired or wireless devices UE 2612C, UE 2612D of FIG. 26, UE 2700 of FIG. 27, virtualization hardware 3004 and virtual machines 3008A, 3008B of FIG. 30, and UE 3106 of FIG. 31, all of which should be considered interchangeable in the examples and embodiments described herein and be within the intended scope of this disclosure, unless otherwise noted.) As shown, wireless communication device UE may include an antenna 1607 (e.g., corresponding to antenna 2722 of FIG. 27), and transceiver circuitry 1601 (also referred to as a transceiver, e.g., corresponding to interface 2712 of FIG. 27 having transmitter 2718 and receiver 2720) including a transmitter and a receiver configured to provide uplink and downlink radio communications with a base station(s) (e.g., corresponding to network node 2610A, 2610B of FIG. 26, network node 2800 of FIG. 28, and network node 3104 of FIG. 31 also referred to as a RAN node) of a radio access network. Wireless communication device UE may also include processing circuitry 1603 (also referred to as a processor, e.g., corresponding to processing circuitry 2702 of FIG. 27, and control system 3012 of FIG. 30) coupled to the transceiver circuitry, and memory circuitry 1605 (also referred to as memory, e.g., corresponding to memory 2710 of FIG. 26) coupled to the processing circuitry. The memory circuitry 1605 may include computer readable program code that when executed by the processing circuitry 1603 causes the processing circuitry to perform operations according to embodiments disclosed herein. According to other embodiments, processing circuitry 1603 may be defined to include memory so that separate memory circuitry is not required. Wireless communication device UE may also include an interface (such as a user interface) coupled with processing circuitry 603, and/or the wireless communication device UE may be incorporated in a vehicle.

As discussed herein, operations of the wireless communication device UE may be performed by processing circuitry 1603 and/or transceiver circuitry 1601. For example, processing circuitry 1603 may control transceiver circuitry 1601 to transmit communications through transceiver circuitry 1601 over a radio interface to a radio access network node (also referred to as a base station) and/or to receive communications through transceiver circuitry 1601 from a RAN node over a radio interface. Moreover, modules may be stored in memory circuitry 1605, and these modules may provide instructions so that when instructions of a module are executed by processing circuitry 1603, processing circuitry 1603 performs respective operations (e.g., operations discussed below with respect to Example Embodiments relating to wireless communication devices). According to some embodiments, a wireless communication device UE 1600 and/or an element(s)/function(s) thereof may be embodied as a virtual node/nodes and/or a virtual machine/machines.

FIG. 17 is a block diagram illustrating elements of a radio access network RAN node 1700 (also referred to as a network node, base station, eNodeB/eNB, gNodeB/gNB, etc.) of a Radio Access Network (RAN) configured to provide cellular communication according to embodiments of inventive concepts. (RAN node 1700 may be provided, for example, as discussed below with respect to network node 2610A, 2610B of FIG. 26, network node 2800 of FIG. 3, hardware 3004 or virtual machine 3008A, 3008B of FIG. 30, and/or base station 3104 of FIG. 31, all of which should be considered interchangeable in the examples and embodiments described herein and be within the intended scope of this disclosure, unless otherwise noted.) As shown, the RAN node may include transceiver circuitry 1701 (also referred to as a transceiver, e.g., corresponding to portions of RF transceiver circuitry 2812 and radio front end circuitry 2818 of FIG. 28) including a transmitter and a receiver configured to provide uplink and downlink radio communications with mobile terminals. The RAN node may include network interface circuitry 1707 (also referred to as a network interface, e.g., corresponding to portions of communication interface 2806 of FIG. 28) configured to provide communications with other nodes (e.g., with other base stations) of the RAN and/or core network CN. The network node may also include processing circuitry 1703 (also referred to as a processor, e.g., corresponding to processing circuitry 2802 of FIG. 28) coupled to the transceiver circuitry, and memory circuitry 1705 (also referred to as memory, e.g., corresponding to memory 2804 of FIG. 28) coupled to the processing circuitry. The memory circuitry 1705 may include computer readable program code that when executed by the processing circuitry 1703 causes the processing circuitry to perform operations according to embodiments disclosed herein. According to other embodiments, processing circuitry 1703 may be defined to include memory so that a separate memory circuitry is not required.

As discussed herein, operations of the RAN node may be performed by processing circuitry 1703, network interface 1707, and/or transceiver 1701. For example, processing circuitry 1703 may control transceiver 11701 to transmit downlink communications through transceiver 401 over a radio interface to one or more mobile terminals UEs and/or to receive uplink communications through transceiver 1701 from one or more mobile terminals UEs over a radio interface. Similarly, processing circuitry 1703 may control network interface 1707 to transmit communications through network interface 1707 to one or more other network nodes and/or to receive communications through network interface from one or more other network nodes. Moreover, modules may be stored in memory 1705, and these modules may provide instructions so that when instructions of a module are executed by processing circuitry 1703, processing circuitry 1703 performs respective operations (e.g., operations discussed below with respect to Example Embodiments relating to RAN nodes). According to some embodiments, RAN node 1700 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 18 is a block diagram illustrating elements of a core network (CN) node (e.g., an SMF (session management function) node, an AMF (access and mobility management function) node, etc.) of a communication network configured to provide cellular communication according to embodiments of inventive concepts. (CN node 1800 may be provided, for example, as discussed below with respect to core network node 2608 of FIG. 26, hardware 3004 or virtual machine 3008A, 3008B of FIG. 30, all of which should be considered interchangeable in the examples and embodiments described herein and be within the intended scope of this disclosure, unless otherwise noted) As shown, the CN node may include network interface circuitry 1807 configured to provide communications with other nodes of the core network and/or the radio access network RAN. The CN node may also include a processing circuitry 1803 (also referred to as a processor) coupled to the network interface circuitry, and memory circuitry 1805 (also referred to as memory) coupled to the processing circuitry. The memory circuitry 1805 may include computer readable program code that when executed by the processing circuitry 1803 causes the processing circuitry to perform operations according to embodiments disclosed herein. According to other embodiments, processing circuitry 1803 may be defined to include memory so that a separate memory circuitry is not required.

As discussed herein, operations of the CN node may be performed by processing circuitry 1803 and/or network interface circuitry 1807. For example, processing circuitry 1803 may control network interface circuitry 1807 to transmit communications through network interface circuitry 1807 to one or more other network nodes and/or to receive communications through network interface circuitry from one or more other network nodes. Moreover, modules may be stored in memory 1805, and these modules may provide instructions so that when instructions of a module are executed by processing circuitry 1803, processing circuitry 1803 performs respective operations (e.g., operations discussed below with respect to Example Embodiments relating to core network nodes). According to some embodiments, CN node 1800 and/or an element(s)/function(s) thereof may be embodied as a virtual node/nodes and/or a virtual machine/machines.

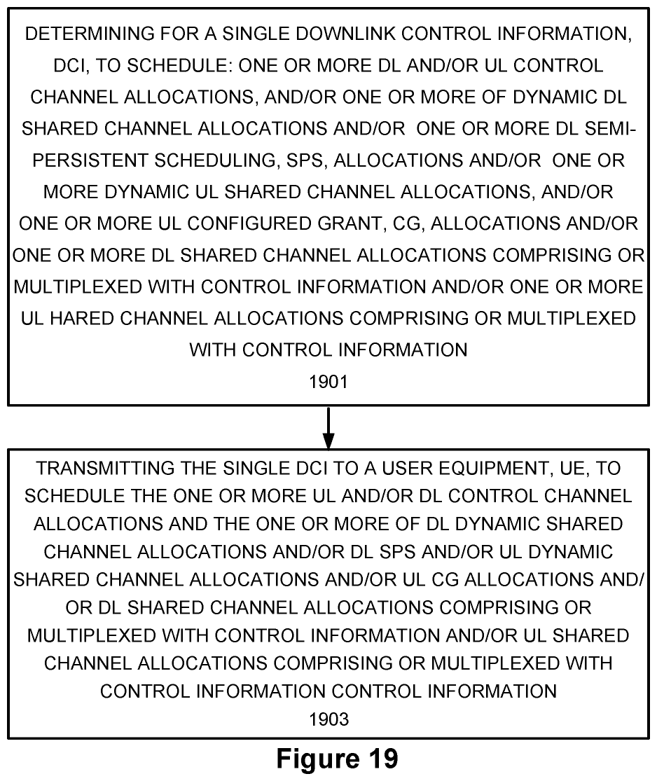

In the description that follows, while the network node may be any of the RAN node 1700, network node 2610A, 2610B, 2800, 3106, hardware 3004, or virtual machine 3008A, 3008B, the RAN node 1700 shall be used to describe the functionality of the operations of the network node. Operations of the RAN node 1700 (implemented using the structure of FIG. 17) will now be discussed with reference to the flow chart of FIG. 19 according to some embodiments of inventive concepts. For example, modules may be stored in memory 1705 of FIG. 17, and these modules may provide instructions so that when the instructions of a module are executed by respective RAN node processing circuitry 1703, processing circuitry 1703 performs respective operations of the flow chart.

Turning now to FIG. 19, in block 1901, the processing circuitry 1703 determines control for a single downlink information, DCI, to schedule one or more DL and/or UL control channel allocations, and/or one or more of dynamic DL shared channel allocations and/or one or more DL semi-persistent scheduling, SPS, allocations and/or one or more dynamic UL shared channel allocations, and/or one or more UL configured grant, CG, allocations, and/or one or more DL shared channel allocations comprising or multiplexed with control information and/or one or more UL shared channel allocations comprising or multiplexed with control information.

An example of UL shared channel allocations comprising or multiplexed with control information is where PUSCH is first transmitted where the PUSCH carries information in UCI about a PDSCH that is transmitted later. Similarly an example of DL shared channel allocations comprising or multiplexed with control information is where PDSCH is first transmitted containing a control flag or the DCI about a PUSCH that is later transmitted.

In block 1903, the processing circuitry 1703 transmits the single DCI to a user equipment, UE, to schedule the one or more UL and/or DL control channel allocations and the one or more of DL dynamic shared channel allocations and/or DL SPS and/or UL dynamic shared channel allocations and/or UL CG allocations and/or DL shared channel allocations comprising or multiplexed with control information and/or UL shared channel allocations comprising or multiplexed with control information control information.

In some embodiments, the processing circuitry 1703 also configures physical signals such as CSI-RS, SRS, and SSB. Thus, the processing circuitry 1703 determines the single DCI to schedule physical shared channels, control channels, and physical signals.

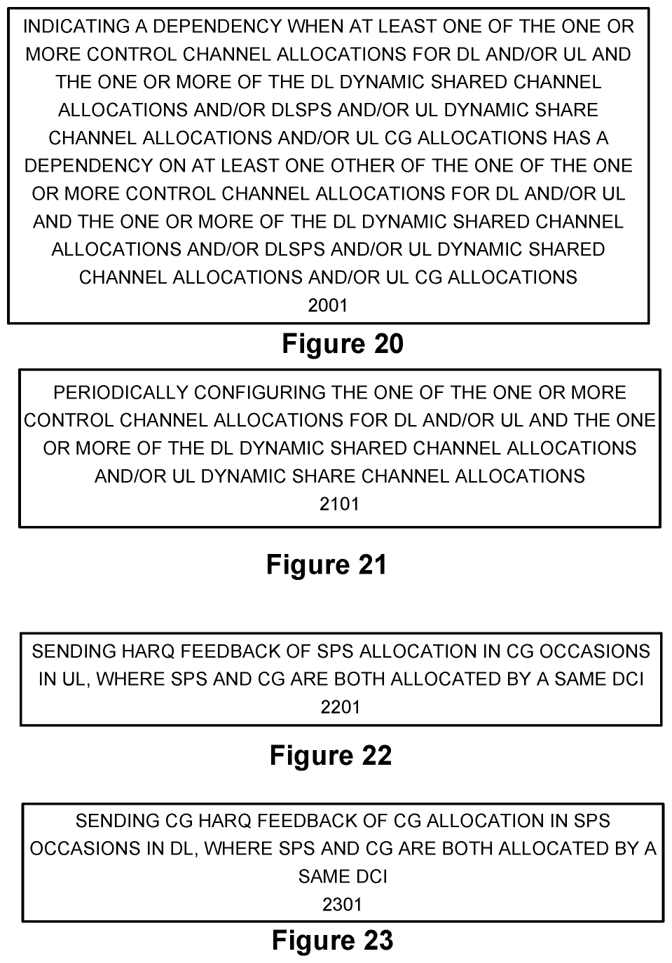

In some embodiments, at least one of the one or more control channel allocations for DL and/or UL and the one or more of the DL dynamic shared channel allocations and/or DLSPS and/or UL dynamic share channel allocations and/or UL CG allocations has a dependency on at least one other of the one of the one or more control channel allocations for DL and/or UL and the one or more of the DL dynamic shared channel allocations and/or DLSPS and/or UL dynamic share channel allocations and/or UL CG allocations. In these embodiments, the processing circuitry 1703 indicates the dependency as illustrated in block 2001 in FIG. 20. The dependency can be provided in the DCI such that transmission parameters are derived by the processing circuitry 1603 of the wireless communication device 1600 that receives the DCI.

In some embodiments, the processing circuitry 1703 indicates the dependency by indicating that a resource allocation of a later transmitted of the one of the one or more control channel allocations for DL and/or UL and the one or more of the DL dynamic shared channel allocations and/or DLSPS and/or UL dynamic share channel allocations and/or UL CG allocations depends on an outcome of an earlier transmitted of the one of the one or more control channel allocations for DL and/or UL and the one or more of the DL dynamic shared channel allocations and/or DLSPS and/or UL dynamic share channel allocations and/or UL CG allocations. In other words, dependency is not deduced from DCI directly, rather dependency information is “hidden” in the decoding process of some transmissions. For example, a DCI allocates a PUSCH and PDSCH. If the UE transmits data on PUSCH containing a UCI #1 (HARQ ID or high PHY priority, etc.), then the gNB sends PDSCH #1 (e.g., eMBB PDSCH), and if UE transmits data on PUSCH containing some a UCI #2 (e.g., a different HARQ ID or low PHY priority, etc.), then gNB sends PDSCH #2 (e.g., URLLC PDSCH)

In other embodiments, the processing circuitry 1703 indicates the dependency by indicating that transmission parameters of the later transmitted of the one of the one or more control channel allocations for DL and/or UL and the one or more of the DL dynamic shared channel allocations and/or DLSPS and/or UL dynamic share channel allocations and/or UL CG allocations depends on an outcome of an earlier transmitted of the one of the one or more control channel allocations for DL and/or UL and the one or more of the DL dynamic shared channel allocations and/or DLSPS and/or UL dynamic share channel allocations and/or UL CG allocations.

In further embodiments, the processing circuitry 1703 indicates the dependency by indicating that at a later transmitted of the one of the one or more control channel allocations for DL and/or UL and the one or more of the DL dynamic shared channel allocations and/or DLSPS and/or UL dynamic share channel allocations and/or UL CG allocations is indicated by flag information included in an earlier transmitted of the one of the one or more control channel allocations for DL and/or UL and the one or more of the DL dynamic shared channel allocations and/or DL SPS and/or UL dynamic share channel allocations and/or UL CG allocations.

In yet other embodiments of inventive concepts, the processing circuitry 1703 configures the single DCI to dynamically configures the one of the one or more control channel allocations for DL and/or UL and the one or more of the DL dynamic shared channel allocations and/or DL SPS and/or UL dynamic share channel allocations and/or UL CG allocations.

In further embodiments, the processing circuitry 1703 derives the dependency from transmission parameters. In yet further embodiments, the processing circuitry 1703 determines the dependency based on decoding of an earlier transmission where the dependency is derived based on the earlier transmission.

Turning to FIG. 21, in some embodiments of inventive concepts, the processing circuitry 1703, in block 2101, periodically configures the one of the one or more control channel allocations for DL and/or UL and the one or more of the DL dynamic shared channel allocations and/or UL dynamic share channel allocations. It should be noted that periodically configuring the allocations includes semi-persistent and/or semi-static allocations.

Turning to FIG. 22, in further embodiments of inventive concepts, the processing circuitry 1703, in block 2201, sends HARQ feedback of SPS allocation in CG occasions in UL, where SPS and CG are both allocated by a same DCI. In a similar embodiment, the processing circuitry 1793, in block 2301 of FIG. 23, sends CG HARQ feedback of CG allocation in SPS occasions in DL, where SPS and CG are both allocated by a same DCI.

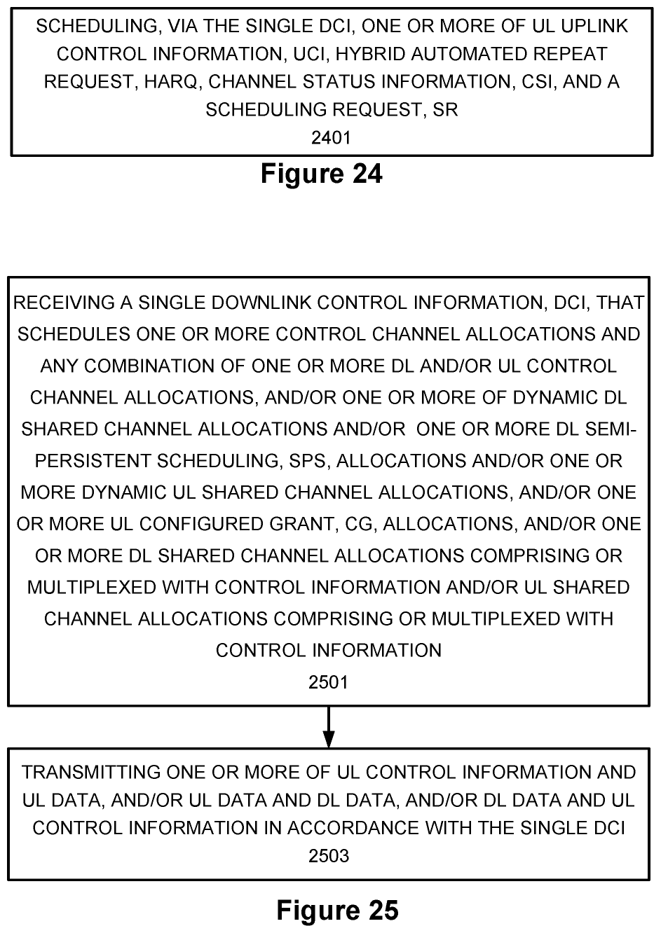

As previously indicated, the processing circuitry 1703 also configures physical signals. This is illustrated in FIG. 24. Turning to FIG. 24, the processing circuitry 1703, in block 2401, schedules, via the single DCI, one or more of UL uplink control information, UCI, hybrid automated repeat request, HARQ, channel status information, CSI, and a scheduling request, SR.

In some embodiments of inventive concepts, the processing circuitry 1703 determines the single DCI by stacking two legacy DCIs and one common cyclic redundancy check, CRC.

In the various embodiments described above, the parameters for the one or more control channel allocations and the one or more of the DL dynamic shared channel allocations and/or the UL dynamic shared channel allocations include one or more of a pointer measured from a PDSCH to a physical uplink control channel, PUCCH, carrying HARQ-ACK codebook, a pointer measured from PDCCH carrying the single DCI to physical uplink shared channel, PUSCH, allocation, and a pointer measured from PDSCH to PUSCH carrying data or HARQ codebook or both data and HARQ codebook. Additionally, a pointer measured from a physical downlink control channel, PDCCH, carrying the single DCI to a physical downlink shared channel, PDSCH, allocation can be provided.

Examples of some of the various embodiments include a pointer measured from a PDSCH to a PUSCH carrying a HARQ-ACK codebook, a pointer measured from PUSCH to PDSCH carrying PUSCH feedback, a pointer measured from a UL channel to a DL channel carrying feedback for the UL channel, etc.

In other embodiments of these various embodiments, the parameters for the one or more control channel allocations and the one or more of the DL dynamic shared channel allocations and/or the UL dynamic shared channel allocations comprises one or more of multiple pointers for multiple allocations, pointers to channels over which feedbacks or HARQ-ACK codebooks are transmitted for some other channels, and pointers with respect to different channels. The multiple pointers could be, for example, shared channels and/or control channels such as a pointer to PSUCH, a pointer to PDSCH, etc. The pointers to channels could be, for example, a pointer measured from a PDSCH to a physical uplink shared channel, PUSCH, carrying HARQ-ACK codebook. An example of the pointers with respect to different channels is where the DCI allocations a PSUCH and PDSCH where the DCI contains a pointer to PUSCH 9 from the DCI) and another pointer to PDSCH (but from PUSCH instead of the DCI).

In other embodiments of inventive concepts, the processing circuitry 1703 can provide an indication in the single DCI so that the single DCI indicates that a transmission over a DL shared channel is subject to one of a partially or fully successful transmission over a UL shared channel or a partially or fully failed transmission over the UL shared channel.

In other embodiments of inventive concepts, the processing circuitry 1703 can provide an indication in the single DCI so that the single DCI indicates that a transmission over the UL shared channel is subject to one of a partially or fully successful transmission over the DL shared channel or a partially or fully failed transmission over the DL shared channel.

In the description that follows, while the wireless communication device may be any of the wireless communication device 1600, wireless device 2612A, 2612B, wired or wireless devices UE 2612C, UE 2612D, UE 2700, virtualization hardware 3004, virtual machines 3008A, 3008B, or UE 3106, the wireless communication device 1600 shall be used to describe the functionality of the operations of the wireless communication device. Operations of the communication device 1600 (implemented using the structure of the block diagram of FIG. 16) will now be discussed with reference to the flow chart of FIG. 25 according to some embodiments of inventive concepts. For example, modules may be stored in memory 1605 of FIG. 16, and these modules may provide instructions so that when the instructions of a module are executed by respective communication device processing circuitry 1603, processing circuitry 1603 performs respective operations of the flow chart.

Turning to FIG. 25, in block 2501, the processing circuitry 1603 receives a single downlink control information, DCI, that schedules one or more control channel allocations and any combination of one or more DL and/or UL control channel allocations, and/or one or more of dynamic DL shared channel allocations and/or one or more DL semi-persistent scheduling, SPS, allocations and/or one or more dynamic UL shared channel allocations, and/or one or more UL configured grant, CG, allocations, and/or one or more DL shared channel allocations comprising or multiplexed with control information and/or UL shared channel allocations comprising or multiplexed with control information.

In block 2503, the processing circuitry 1603 transmits one or more of UL control information and UL data, and/or UL data and DL data, and/or DL data and UL control information in accordance with the single DCI.

In some embodiments of inventive concepts, the processing circuitry 1603 transmits one or more of UL control information, UL data and DL data in accordance with the single DCI by, responsive to UL PUSCH being allocated, uses the PUSCH to transmit UL data and/or HARQ-ACK codebook of one or more earlier transmitted PDSCHs. In yet other embodiments, the processing circuitry 1603, responsive to UL PUCCH being allocated, uses the PUCCH to transmit HARQ-ACK codebook of one or more earlier transmitted PDSCHs.

In further embodiments of inventive concepts, the processing circuitry 1603 transmits one or more of UL control information, UL data and DL data in accordance with the single DCI by, responsive to the DCI scheduling multiple grants corresponding a PUSCH allocation for UL data transmission, and/or PUCCH allocation for power reporting, transmits UL data transmission on the PUSCH and/or reporting power information on the PUCCH.

In yet other embodiments of inventive concepts, the processing circuitry 1603 transmits one or more of UL control information, UL data and DL data in accordance with the single DCI by responsive to DL resource allocation and UL resource allocation is scheduled in the single DCI: generating UL data and transmitting UL data using the UL resource allocated only if DL PDSCH is decoded successfully; or generating DL data and transmitting DL data using the DL resource allocated only if UL PUSCH is decoded successfully.

In still further embodiments of inventive concepts, the processing circuitry 1603 schedules multiple UL and DL transmissions in the single DCI where some parameters of the UL transmissions are derived from flag information which is multiplexed with associated DL transmission.

In yet other embodiments of inventive concepts, the processing circuitry 1703, responsive to the single DCI scheduling a pair of UL and DL transmissions, obtains from the single DCI one or more of: a same hybrid automatic repeat request, HARQ, process ID; a same modulation and coding scheme, MCS, scheme; a same priority; a same reliability target; a same latency budget; a same redundancy value, RV, id or RV sequence; a same Carrier id; a same; a same bandwidth part, BWP, id; and/or a same new data indicator, NDI.

FIG. 26 shows an example of a communication system 2600 in accordance with some embodiments.

In the example, the communication system 2600 includes a telecommunication network 2602 that includes an access network 2604, such as a radio access network (RAN), and a core network 2606, which includes one or more core network nodes 2608. The access network 2604 includes one or more access network nodes, such as network nodes 2610a and 2610b (one or more of which may be generally referred to as network nodes 2610), or any other similar 3^{rd} Generation Partnership Project (3GPP) access node or non-3GPP access point. The network nodes 2610 facilitate direct or indirect connection of user equipment (UE), such as by connecting UEs 2612a, 2612b, 2612c, and 2612d (one or more of which may be generally referred to as UEs 2612) to the core network 2606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2600 may include any number of wired or wireless networks, network nodes, UEs, and/or any other components or systems that may facilitate or participate in the communication of data and/or signals whether via wired or wireless connections. The communication system 2600 may include and/or interface with any type of communication, telecommunication, data, cellular, radio network, and/or other similar type of system.

The UEs 2612 may be any of a wide variety of communication devices, including wireless devices arranged, configured, and/or operable to communicate wirelessly with the network nodes 2610 and other communication devices. Similarly, the network nodes 2610 are arranged, capable, configured, and/or operable to communicate directly or indirectly with the UEs 2612 and/or with other network nodes or equipment in the telecommunication network 2602 to enable and/or provide network access, such as wireless network access, and/or to perform other functions, such as administration in the telecommunication network 2602.

In the depicted example, the core network 2606 connects the network nodes 2610 to one or more hosts, such as host 2616. These connections may be direct or indirect via one or more intermediary networks or devices. In other examples, network nodes may be directly coupled to hosts. The core network 2606 includes one more core network nodes (e.g., core network node 2608) that are structured with hardware and software components. Features of these components may be substantially similar to those described with respect to the UEs, network nodes, and/or hosts, such that the descriptions thereof are generally applicable to the corresponding components of the core network node 2608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2616 may be under the ownership or control of a service provider other than an operator or provider of the access network 2604 and/or the telecommunication network 2602, and may be operated by the service provider or on behalf of the service provider. The host 2616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2600 of FIG. 26 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2602 is a cellular network that implements 3GPP standardized features. Accordingly, the telecommunications network 2602 may support network slicing to provide different logical networks to different devices that are connected to the telecommunication network 2602. For example, the telecommunications network 2602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2612 are configured to transmit and/or receive information without direct human interaction. For instance, a UE may be designed to transmit information to the access network 2604 on a predetermined schedule, when triggered by an internal or external event, or in response to requests from the access network 2604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2614 communicates with the access network 2604 to facilitate indirect communication between one or more UEs (e.g., UE 2612c and/or 2612d) and network nodes (e.g., network node 2610b). In some examples, the hub 2614 may be a controller, router, content source and analytics, or any of the other communication devices described herein regarding UEs. For example, the hub 2614 may be a broadband router enabling access to the core network 2606 for the UEs. As another example, the hub 2614 may be a controller that sends commands or instructions to one or more actuators in the UEs. Commands or instructions may be received from the UEs, network nodes 2610, or by executable code, script, process, or other instructions in the hub 2614. As another example, the hub 2614 may be a data collector that acts as temporary storage for UE data and, in some embodiments, may perform analysis or other processing of the data. As another example, the hub 2614 may be a content source. For example, for a UE that is a VR headset, display, loudspeaker or other media delivery device, the hub 2614 may retrieve VR assets, video, audio, or other media or data related to sensory information via a network node, which the hub 2614 then provides to the UE either directly, after performing local processing, and/or after adding additional local content. In still another example, the hub 2614 acts as a proxy server or orchestrator for the UEs, in particular in if one or more of the UEs are low energy IoT devices.

The hub 2614 may have a constant/persistent or intermittent connection to the network node 2610b. The hub 2614 may also allow for a different communication scheme and/or schedule between the hub 2614 and UEs (e.g., UE 2612c and/or 2612d), and between the hub 2614 and the core network 2606. In other examples, the hub 2614 is connected to the core network 2606 and/or one or more UEs via a wired connection. Moreover, the hub 2614 may be configured to connect to an M2M service provider over the access network 2604 and/or to another UE over a direct connection. In some scenarios, UEs may establish a wireless connection with the network nodes 2610 while still connected via the hub 2614 via a wired or wireless connection. In some embodiments, the hub 2614 may be a dedicated hub—that is, a hub whose primary function is to route communications to/from the UEs from/to the network node 2610b. In other embodiments, the hub 2614 may be a non-dedicated hub—that is, a device which is capable of operating to route communications between the UEs and network node 2610b, but which is additionally capable of operating as a communication start and/or end point for certain data channels.

FIG. 27 shows a UE 2700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2700 includes processing circuitry 2702 that is operatively coupled via a bus 2704 to an input/output interface 2706, a power source 2708, a memory 2710, a communication interface 2712, and/or any other component, or any combination thereof. Certain UEs may utilize all or a subset of the components shown in FIG. 27. The level of integration between the components may vary from one UE to another UE. Further, certain UEs may contain multiple instances of a component, such as multiple processors, memories, transceivers, transmitters, receivers, etc.

The processing circuitry 2702 is configured to process instructions and data and may be configured to implement any sequential state machine operative to execute instructions stored as machine-readable computer programs in the memory 2710. The processing circuitry 2702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2702 may include multiple central processing units (CPUs).

In the example, the input/output interface 2706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2708 is structured as a battery or battery pack. Other types of power sources, such as an external power source (e.g., an electricity outlet), photovoltaic device, or power cell, may be used. The power source 2708 may further include power circuitry for delivering power from the power source 2708 itself, and/or an external power source, to the various parts of the UE 2700 via input circuitry or an interface such as an electrical power cable. Delivering power may be, for example, for charging of the power source 2708. Power circuitry may perform any formatting, converting, or other modification to the power from the power source 2708 to make the power suitable for the respective components of the UE 2700 to which power is supplied.

The memory 2710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2710 includes one or more application programs 2714, such as an operating system, web browser application, a widget, gadget engine, or other application, and corresponding data 2716. The memory 2710 may store, for use by the UE 2700, any of a variety of various operating systems or combinations of operating systems.

The memory 2710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2710 may allow the UE 2700 to access instructions, application programs and the like, stored on transitory or non-transitory memory media, to off-load data, or to upload data. An article of manufacture, such as one utilizing a communication system may be tangibly embodied as or in the memory 2710, which may be or comprise a device-readable storage medium.

The processing circuitry 2702 may be configured to communicate with an access network or other network using the communication interface 2712. The communication interface 2712 may comprise one or more communication subsystems and may include or be communicatively coupled to an antenna 2722. The communication interface 2712 may include one or more transceivers used to communicate, such as by communicating with one or more remote transceivers of another device capable of wireless communication (e.g., another UE or a network node in an access network). Each transceiver may include a transmitter 2718 and/or a receiver 2720 appropriate to provide network communications (e.g., optical, electrical, frequency allocations, and so forth). Moreover, the transmitter 2718 and receiver 2720 may be coupled to one or more antennas (e.g., antenna 2722) and may share circuit components, software or firmware, or alternatively be implemented separately.

In the illustrated embodiment, communication functions of the communication interface 2712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2700 shown in FIG. 27.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 28 shows a network node 2800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2800 includes a processing circuitry 2802, a memory 2804, a communication interface 2806, and a power source 2808. The network node 2800 may be composed of multiple physically separate components (e.g., a NodeB component and a RNC component, or a BTS component and a BSC component, etc.), which may each have their own respective components. In certain scenarios in which the network node 2800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2800 may be configured to support multiple radio access technologies (RATs). In such embodiments, some components may be duplicated (e.g., separate memory 2804 for different RATs) and some components may be reused (e.g., a same antenna 2810 may be shared by different RATs). The network node 2800 may also include multiple sets of the various illustrated components for different wireless technologies integrated into network node 2800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2800.

The processing circuitry 2802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2800 components, such as the memory 2804, to provide network node 2800 functionality.

In some embodiments, the processing circuitry 2802 includes a system on a chip (SOC). In some embodiments, the processing circuitry 2802 includes one or more of radio frequency (RF) transceiver circuitry 2812 and baseband processing circuitry 2814. In some embodiments, the radio frequency (RF) transceiver circuitry 2812 and the baseband processing circuitry 2814 may be on separate chips (or sets of chips), boards, or units, such as radio units and digital units. In alternative embodiments, part or all of RF transceiver circuitry 2812 and baseband processing circuitry 2814 may be on the same chip or set of chips, boards, or units.

The memory 2804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2802. The memory 2804 may store any suitable instructions, data, or information, including a computer program, software, an application including one or more of logic, rules, code, tables, and/or other instructions capable of being executed by the processing circuitry 2802 and utilized by the network node 2800. The memory 2804 may be used to store any calculations made by the processing circuitry 2802 and/or any data received via the communication interface 2806. In some embodiments, the processing circuitry 2802 and memory 2804 is integrated.

The communication interface 2806 is used in wired or wireless communication of signaling and/or data between a network node, access network, and/or UE. As illustrated, the communication interface 2806 comprises port(s)/terminal(s) 2816 to send and receive data, for example to and from a network over a wired connection. The communication interface 2806 also includes radio front-end circuitry 2818 that may be coupled to, or in certain embodiments a part of, the antenna 2810. Radio front-end circuitry 2818 comprises filters 2820 and amplifiers 2822. The radio front-end circuitry 2818 may be connected to an antenna 2810 and processing circuitry 2802. The radio front-end circuitry may be configured to condition signals communicated between antenna 2810 and processing circuitry 2802. The radio front-end circuitry 2818 may receive digital data that is to be sent out to other network nodes or UEs via a wireless connection. The radio front-end circuitry 2818 may convert the digital data into a radio signal having the appropriate channel and bandwidth parameters using a combination of filters 2820 and/or amplifiers 2822. The radio signal may then be transmitted via the antenna 2810. Similarly, when receiving data, the antenna 2810 may collect radio signals which are then converted into digital data by the radio front-end circuitry 2818. The digital data may be passed to the processing circuitry 2802. In other embodiments, the communication interface may comprise different components and/or different combinations of components.

In certain alternative embodiments, the network node 2800 does not include separate radio front-end circuitry 2818, instead, the processing circuitry 2802 includes radio front-end circuitry and is connected to the antenna 2810. Similarly, in some embodiments, all or some of the RF transceiver circuitry 2812 is part of the communication interface 2806. In still other embodiments, the communication interface 2806 includes one or more ports or terminals 2816, the radio front-end circuitry 2818, and the RF transceiver circuitry 2812, as part of a radio unit (not shown), and the communication interface 2806 communicates with the baseband processing circuitry 2814, which is part of a digital unit (not shown).

The antenna 2810 may include one or more antennas, or antenna arrays, configured to send and/or receive wireless signals. The antenna 2810 may be coupled to the radio front-end circuitry 2818 and may be any type of antenna capable of transmitting and receiving data and/or signals wirelessly. In certain embodiments, the antenna 2810 is separate from the network node 2800 and connectable to the network node 2800 through an interface or port.

The antenna 2810, communication interface 2806, and/or the processing circuitry 2802 may be configured to perform any receiving operations and/or certain obtaining operations described herein as being performed by the network node. Any information, data and/or signals may be received from a UE, another network node and/or any other network equipment. Similarly, the antenna 2810, the communication interface 2806, and/or the processing circuitry 2802 may be configured to perform any transmitting operations described herein as being performed by the network node. Any information, data and/or signals may be transmitted to a UE, another network node and/or any other network equipment.

The power source 2808 provides power to the various components of network node 2800 in a form suitable for the respective components (e.g., at a voltage and current level needed for each respective component). The power source 2808 may further comprise, or be coupled to, power management circuitry to supply the components of the network node 2800 with power for performing the functionality described herein. For example, the network node 2800 may be connectable to an external power source (e.g., the power grid, an electricity outlet) via an input circuitry or interface such as an electrical cable, whereby the external power source supplies power to power circuitry of the power source 2808. As a further example, the power source 2808 may comprise a source of power in the form of a battery or battery pack which is connected to, or integrated in, power circuitry. The battery may provide backup power should the external power source fail.

Embodiments of the network node 2800 may include additional components beyond those shown in FIG. 28 for providing certain aspects of the network node's functionality, including any of the functionality described herein and/or any functionality necessary to support the subject matter described herein. For example, the network node 2800 may include user interface equipment to allow input of information into the network node 2800 and to allow output of information from the network node 2800. This may allow a user to perform diagnostic, maintenance, repair, and other administrative functions for the network node 2800.

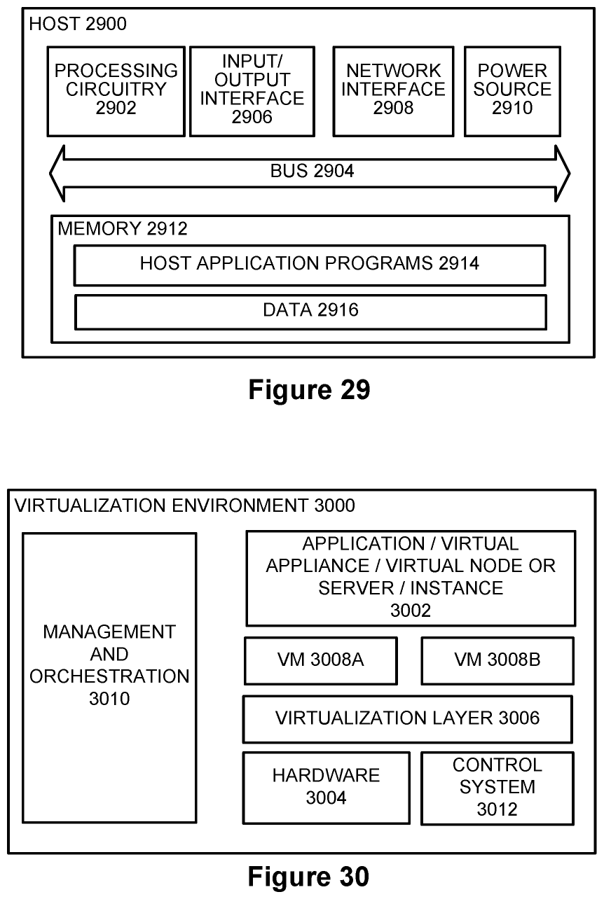

FIG. 29 is a block diagram of a host 2900, which may be an embodiment of the host 2616 of FIG. 26, in accordance with various aspects described herein. As used herein, the host 2900 may be or comprise various combinations hardware and/or software, including a standalone server, a blade server, a cloud-implemented server, a distributed server, a virtual machine, container, or processing resources in a server farm. The host 2900 may provide one or more services to one or more UEs.

The host 2900 includes processing circuitry 2902 that is operatively coupled via a bus 2904 to an input/output interface 2906, a network interface 2908, a power source 2910, and a memory 2912. Other components may be included in other embodiments. Features of these components may be substantially similar to those described with respect to the devices of previous figures, such as FIGS. 27 and 28, such that the descriptions thereof are generally applicable to the corresponding components of host 2900.

The memory 2912 may include one or more computer programs including one or more host application programs 2914 and data 2916, which may include user data, e.g., data generated by a UE for the host 2900 or data generated by the host 2900 for a UE. Embodiments of the host 2900 may utilize only a subset or all of the components shown. The host application programs 2914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2914 may also provide for user authentication and licensing checks and may periodically report health, routes, and content availability to a central node, such as a device in or on the edge of a core network. Accordingly, the host 2900 may select and/or indicate a different host for over-the-top services for a UE. The host application programs 2914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 30 is a block diagram illustrating a virtualization environment 3000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3006 (also referred to as hypervisors or virtual machine monitors (VMMs)), provide VMs 3008a and 3008b (one or more of which may be generally referred to as VMs 3008), and/or perform any of the functions, features and/or benefits described in relation with some embodiments described herein. The virtualization layer 3006 may present a virtual operating platform that appears like networking hardware to the VMs 3008.

The VMs 3008 comprise virtual processing, virtual memory, virtual networking or interface and virtual storage, and may be run by a corresponding virtualization layer 3006. Different embodiments of the instance of a virtual appliance 3002 may be implemented on one or more of VMs 3008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3008 may be a software implementation of a physical machine that runs programs as if they were executing on a physical, non-virtualized machine. Each of the VMs 3008, and that part of hardware 3004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3008 on top of the hardware 3004 and corresponds to the application 3002.

Hardware 3004 may be implemented in a standalone network node with generic or specific components. Hardware 3004 may implement some functions via virtualization. Alternatively, hardware 3004 may be part of a larger cluster of hardware (e.g. such as in a data center or CPE) where many hardware nodes work together and are managed via management and orchestration 3010, which, among others, oversees lifecycle management of applications 3002. In some embodiments, hardware 3004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3012 which may alternatively be used for communication between hardware nodes and radio units.

FIG. 31 shows a communication diagram of a host 3102 communicating via a network node 3104 with a UE 3106 over a partially wireless connection in accordance with some embodiments. Example implementations, in accordance with various embodiments, of the UE (such as a UE 2612a of FIG. 26 and/or UE 2700 of FIG. 27), network node (such as network node 2610a of FIG. 26 and/or network node 2800 of FIG. 28), and host (such as host 2616 of FIG. 26 and/or host 2900 of FIG. 29) discussed in the preceding paragraphs will now be described with reference to FIG. 31.

Like host 2900, embodiments of host 3102 include hardware, such as a communication interface, processing circuitry, and memory. The host 3102 also includes software, which is stored in or accessible by the host 3102 and executable by the processing circuitry. The software includes a host application that may be operable to provide a service to a remote user, such as the UE 3106 connecting via an over-the-top (OTT) connection 3150 extending between the UE 3106 and host 3102. In providing the service to the remote user, a host application may provide user data which is transmitted using the OTT connection 3150.

The network node 3104 includes hardware enabling it to communicate with the host 3102 and UE 3106. The connection 3160 may be direct or pass through a core network (like core network 2606 of FIG. 26) and/or one or more other intermediate networks, such as one or more public, private, or hosted networks. For example, an intermediate network may be a backbone network or the Internet.

The UE 3106 includes hardware and software, which is stored in or accessible by UE 3106 and executable by the UE's processing circuitry. The software includes a client application, such as a web browser or operator-specific “app” that may be operable to provide a service to a human or non-human user via UE 3106 with the support of the host 3102. In the host 3102, an executing host application may communicate with the executing client application via the OTT connection 3150 terminating at the UE 3106 and host 3102. In providing the service to the user, the UE's client application may receive request data from the host's host application and provide user data in response to the request data. The OTT connection 3150 may transfer both the request data and the user data. The UE's client application may interact with the user to generate the user data that it provides to the host application through the OTT connection 3150.

The OTT connection 3150 may extend via a connection 3160 between the host 3102 and the network node 3104 and via a wireless connection 3170 between the network node 3104 and the UE 3106 to provide the connection between the host 3102 and the UE 3106. The connection 3160 and wireless connection 3170, over which the OTT connection 3150 may be provided, have been drawn abstractly to illustrate the communication between the host 3102 and the UE 3106 via the network node 3104, without explicit reference to any intermediary devices and the precise routing of messages via these devices.

As an example of transmitting data via the OTT connection 3150, in step 3108, the host 3102 provides user data, which may be performed by executing a host application. In some embodiments, the user data is associated with a particular human user interacting with the UE 3106. In other embodiments, the user data is associated with a UE 3106 that shares data with the host 3102 without explicit human interaction. In step 3110, the host 3102 initiates a transmission carrying the user data towards the UE 3106. The host 3102 may initiate the transmission responsive to a request transmitted by the UE 3106. The request may be caused by human interaction with the UE 3106 or by operation of the client application executing on the UE 3106. The transmission may pass via the network node 3104, in accordance with the teachings of the embodiments described throughout this disclosure. Accordingly, in step 3112, the network node 3104 transmits to the UE 3106 the user data that was carried in the transmission that the host 3102 initiated, in accordance with the teachings of the embodiments described throughout this disclosure. In step 3114, the UE 3106 receives the user data carried in the transmission, which may be performed by a client application executed on the UE 3106 associated with the host application executed by the host 3102.

In some examples, the UE 3106 executes a client application which provides user data to the host 3102. The user data may be provided in reaction or response to the data received from the host 3102. Accordingly, in step 3116, the UE 3106 may provide user data, which may be performed by executing the client application. In providing the user data, the client application may further consider user input received from the user via an input/output interface of the UE 3106. Regardless of the specific manner in which the user data was provided, the UE 3106 initiates, in step 3118, transmission of the user data towards the host 3102 via the network node 3104. In step 3120, in accordance with the teachings of the embodiments described throughout this disclosure, the network node 3104 receives user data from the UE 3106 and initiates transmission of the received user data towards the host 3102. In step 3122, the host 3102 receives the user data carried in the transmission initiated by the UE 3106.

One or more of the various embodiments improve the performance of OTT services provided to the UE 3106 using the OTT connection 3150, in which the wireless connection 3170 forms the last segment.

In an example scenario, factory status information may be collected and analyzed by the host 3102. As another example, the host 3102 may process audio and video data which may have been retrieved from a UE for use in creating maps. As another example, the host 3102 may collect and analyze real-time data to assist in controlling vehicle congestion (e.g., controlling traffic lights). As another example, the host 3102 may store surveillance video uploaded by a UE. As another example, the host 3102 may store or control access to media content such as video, audio, VR or AR which it can broadcast, multicast or unicast to UEs. As other examples, the host 3102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3150 between the host 3102 and UE 3106, in response to variations in the measurement results. The measurement procedure and/or the network functionality for reconfiguring the OTT connection may be implemented in software and hardware of the host 3102 and/or UE 3106. In some embodiments, sensors (not shown) may be deployed in or in association with other devices through which the OTT connection 3150 passes; the sensors may participate in the measurement procedure by supplying values of the monitored quantities exemplified above, or supplying values of other physical quantities from which software may compute or estimate the monitored quantities. The reconfiguring of the OTT connection 3150 may include message format, retransmission settings, preferred routing etc.; the reconfiguring need not directly alter the operation of the network node 3104. Such procedures and functionalities may be known and practiced in the art. In certain embodiments, measurements may involve proprietary UE signaling that facilitates measurements of throughput, propagation times, latency and the like, by the host 3102. The measurements may be implemented in that software causes messages to be transmitted, in particular empty or ‘dummy’ messages, using the OTT connection 3150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The invention claimed is:

1.-36. (canceled)

37. A method performed in a radio access network (RAN) node of a wireless network, comprising:
determining for a single downlink control information (DCI) to schedule one or more downlink (DL) and/or uplink (UL) control channel allocations and one or more of:
one or more of dynamic DL shared channel allocations, and/or
one or more dynamic UL shared channel allocations, and/or
one or more UL configured grant (CG) allocations, and/or
one or more DL shared channel allocations comprising or multiplexed with control information, and/or
one or more UL shared channel allocations comprising or multiplexed with control information; and
transmitting the single DCI to a user equipment (UE) to schedule the one or more UL and/or DL control channel allocations and the one or more of:
one or more of dynamic DL shared channel allocations, and/or
one or more dynamic UL shared channel allocations, and/or
one or more UL configured grant (CG) allocations, and/or
one or more DL shared channel allocations comprising or multiplexed with control information, and/or
one or more UL shared channel allocations comprising or multiplexed with control information.

38. The method of claim 37, wherein at least one of the one or more DL and/or UL control channel allocations and the one or more of the one or more dynamic DL shared channel allocations and/or the one or more dynamic UL shared channel allocations and/or the one or more UL CG allocations has a dependency on at least one other of the one of the one or more DL and/or UL control channel allocations and the one or more of the one or more dynamic DL shared channel allocations and/or the one o more dynamic UL shared channel allocations and/or the one or more UL CG allocations.

39. The method of claim 38, further comprising indicating the dependency.

40. The method of claim 39, wherein indicating the dependency comprises indicating that a resource allocation of a later transmitted of the one of the one or more DL and/or UL control channel allocations and the one or more of the one or more dynamic DL shared channel allocations and/or the one or more dynamic UL shared channel allocations and/or the one or more UL CG allocations depends on an outcome of an earlier transmitted of the one of the one or more DL and/or UL control channel allocations and the one or more of the one or more dynamic DL shared channel allocations and/or the one or more dynamic UL shared channel allocations and/or the one or more UL CG allocations.

41. The method of claim 39, wherein indicating the dependency comprises indicating that transmission parameters of the later transmitted of the one of the one or more DL and/or UL control channel allocations and the one or more of the one or more dynamic DL shared channel allocations and/or the one or more dynamic UL shared channel allocations and/or the one or more UL CG allocations depends on an outcome of an earlier transmitted of the one of the one or more DL and/or UL control channel allocations and the one or more of the one or more dynamic DL shared channel allocations and/or the one or more dynamic UL shared channel allocations and/or the one or more UL CG allocations.

42. The method of claim 39, wherein indicating the dependency of a later transmitted of the one of the one or more DL and/or UL control channel allocations and the one or more of the one or more dynamic DL shared channel allocations and/or the one or more dynamic UL shared channel allocations and/or the one or more UL CG allocations is indicated by flag information included in an earlier transmitted of the one of the one or more DL and/or UL control channel allocations and the one or more of the one or more dynamic DL shared channel allocations and/or the one or more dynamic UL shared channel allocations and/or the one or more UL CG allocations.

43. The method of claim 38, further comprising deriving the dependency from transmission parameters.

44. The method of claim 38, further comprising determining the dependency based on decoding of an earlier transmission where the dependency is derived based on the earlier transmission.

45. The method of claim 37 wherein the single DCI dynamically configures the one of the one or more DL and/or UL control channel allocations and the one or more of the one or more dynamic DL shared channel allocations and/or the one or more dynamic UL shared channel allocations and/or the one or more UL CG allocations.

46. The method of claim 37 further comprising periodically configuring the one of the one or more DL and/or UL control channel allocations and the one or more of the one or more dynamic DL shared channel allocations and/or the one or more dynamic UL shared channel allocations.

47. The method of claim 37, further comprising scheduling, via the single DCI, one or more of UL uplink control information (UCI) hybrid automated repeat request (HARQ) channel status information (CSI) and a scheduling request (SR).

48. The method of claim 37 wherein determining the single DCI comprises stacking two legacy DCIs and one common cyclic redundancy check (CRC).

49. The method of claim 41, wherein the transmission parameters for the one or more DL and/or UL control channel allocations and the one or more of the one or more dynamic DL shared channel allocations and/or the one or more dynamic UL shared channel allocations comprises one or more of:
a pointer measured from a Physical Downlink Shared Channel (PDSCH) to a physical uplink control channel (PUCCH) carrying a HARQ-ACK codebook,
a pointer measured from a Physical Downlink Control Channel (PDCCH) carrying the single DCI to a physical uplink shared channel (PUSCH) allocation, and
a pointer measured from PDSCH to PUSCH carrying data or a HARQ codebook or both data and a HARQ codebook.

50. A method performed in a user equipment, UE, the method comprising:
receiving a single downlink control information (DCI) that schedules one or more downlink (DL) and/or uplink (UL) control channel allocations and one or more of:
one or more dynamic DL shared channel allocations, and/or
one or more dynamic UL shared channel allocations, and/or
one or more UL configured grant (CG) allocations, and/or
one or more DL shared channel allocations comprising or multiplexed with control information, and/or
one or more UL shared channel allocations comprising or multiplexed with control information; and
in accordance with the single DCI, transmitting UL control information and UL data, and/or transmitting UL data and receiving DL data, and/or receiving DL data and transmitting UL control information.

51. The method of claim 50 wherein transmitting UL control information or UL data and DL data in accordance with the single DCI comprises, responsive to the DCI scheduling multiple grants corresponding to a physical uplink shared channel (PUSCH) allocation for UL data transmission, and/or physical uplink control channel (PUCCH) allocation for power reporting:
transmitting an UL data transmission on the PUSCH; and/or
reporting power information on the PUCCH or in UL HARQ feedback, or UCI or in scheduling requests or in CG-UCI.

52. The method of claim 51 wherein receiving DL data in accordance with the single DCI comprises, responsive to the DCI scheduling multiple grants corresponding to a physical uplink shared channel (PUSCH) allocation for UL data transmission, and/or physical downlink control channel (PDCCH) allocation for reporting feedback, and/or DFI, and/or a DCI indication, and/or a preemption command, and/or a cancellation command, and/or scheduling parameters:
receiving DL data transmission on the physical downlink shared channel (PDSCH).

53. The method of claim 50 wherein transmitting UL data in accordance with the single DCI comprises, responsive to DL resource allocation and UL resource allocation is scheduled in the single DCI, generating specific UL data and transmitting specific UL data using the UL resource allocated only if DL physical downlink shared channel (PDSCH) is decoded successfully.

54. The method of claim 50, wherein the single DCI schedules multiple UL and DL transmissions where some parameters of the UL transmissions are derived from flag information which is multiplexed with associated DL transmission.

55. A radio access network (RAN) node comprising:
processing circuitry; and
a memory coupled with the processing circuitry, wherein the memory includes instructions that when executed by the processing circuitry causes the RAN node to:
determine for a single downlink control information (DCI) to schedule one or more downlink (DL) and/or uplink (UL) control channel allocations and one or more of:
one or more of dynamic DL shared channel allocations, and/or
one or more dynamic UL shared channel allocations, and/or
one or more UL configured grant (CG) allocations, and/or
one or more DL shared channel allocations comprising or multiplexed with control information, and/or
one or more UL shared channel allocations comprising or multiplexed with control information; and
transmit the single DCI to a user equipment (UE) to schedule the one or more UL and/or DL control channel allocations and the one or more of:
one or more of dynamic DL shared channel allocations, and/or
one or more dynamic UL shared channel allocations, and/or
one or more UL configured grant (CG) allocations, and/or
one or more DL shared channel allocations comprising or multiplexed with control information, and/or
one or more UL shared channel allocations comprising or multiplexed with control information.

56. A user equipment (UE), comprising:
processing circuitry; and
a memory coupled with the processing circuitry, wherein the memory includes instructions that when executed by the processing circuitry causes the UE to perform operations comprising:
receive a single downlink control information (DCI) that schedules one or more downlink (DL) and/or uplink (UL) control channel allocations and one or more of:
one or more dynamic DL shared channel allocations, and/or
one or more dynamic UL shared channel allocations, and/or
one or more UL configured grant (CG) allocations, and/or
one or more DL shared channel allocations comprising or multiplexed with control information, and/or
one or more UL shared channel allocations comprising or multiplexed with control information; and
in accordance with the single DCI, transmit UL control information and UL data, and/or transmitting UL data and receiving DL data, and/or receiving DL data and transmitting UL control information.
